(19) United States
(12) Patent Application Publication
(10) Pub. No.: US 2002/0190710 A1
(43) Pub. Date: Dec. 19, 2002

(54) Magnetic length measuring device

(75) Inventors: Klaus-Manfred Steinich, Poering-Zorneding (DE); Peter Wirth, Eching (DE)

Correspondence Address: HEAD, JOHNSON & KACHIGIAN, 228 W 17TH PLACE, TULSA, OK, 74119, US

(73) Assignee: ASM Automation Sensorik Messtechnik GmbH

(21) Appl. No.: 10/073,629

(22) Filed: Feb. 11, 2002

(30) Foreign Application Priority Data
Feb. 13, 2001 (DE) 101 06 479.9
May 15, 2001 (DE) 101 23 539.9

(51) Int. Cl. G01B 7/14; G01B 7/30

(52) U.S. Cl. 324/207.24; 324/207.25

(57) ABSTRACT

Length measuring devices in which the pitch division on the measuring scale involves differing magnetisation which is sensed by means of a sensor unit are subsequently adjustable in terms of the resolution afforded. For the purposes of improved utility this so-called interpolator circuit is not disposed in a separate fixedly mounted housing which is separate from the movable sensor unit, but directly within the sensor unit.

### I. FIELD OF USE

The invention concerns a length measuring device.

### II. TECHNICAL BACKGROUND

Arranged on the periphery of a cylinder, such a length measuring device can naturally basically also be used for angle measurement.

The length measuring device includes on the one hand a measuring scale on which the length units are recorded and a sensor unit which is moved in the measuring direction relative to the measuring scale. In general, that arrangement records how many length units are covered, that is to say entirely or partially travelled over, in that relative movement on the part of the sensor unit. The absolute position at the end of the relative movement can only be calculated if the starting position prior to the relative movement is known.

For that purpose, the straight or curved measuring scale only has in a single track or in a plurality of tracks in mutually juxtaposed relationship, in succession in the measuring direction, respective codings, in most cases regular and periodic codings, with the pitch spacing being different from one track to another. In addition, provided along the measuring section, in general mostly only at a single lengthwise position, is a reference mark, the position of which represents the absolute zero position and which therefore, for the device to be set in operation, firstly has to be travelled over once in order to predetermine an absolute start value.

In addition however length measuring devices which measure in absolute terms are also known. In that case, by virtue of the design of the measuring scale divisions and the evaluation process involved, for example by only once setting the sensor to a desired location on the measuring scale, it is possible to directly ascertain the absolute position of the sensor on the measuring scale, without relative displacement of the sensor with respect to the measuring scale and without initially having to move to a reference point on the measuring scale.

Irrespective of whether the device involves an incremental or an absolute length measuring system, the measuring device according to the invention includes one or more or a multiplicity of magnets which provide for modulation of the signal to be detected. For example, the individual length units are disposed on the measuring scale in succession in the measuring direction, in the form of different magnets or magnetisation effects, for example in the form of segments of alternate polarity which are each of the same length in the measuring direction.

The sensor unit which is moved relative thereto in the measuring direction and which, besides the actual sensor, generally already includes at least parts of the electronic evaluation system, detects the magnetic field which changes continuously in the measuring direction, in the form of an analog signal, as a sinusoidal oscillation or a sine-like but regular oscillation. A major advantage of this method is the fact that the sensor can be guided at a spacing, that is to say in a contact-less manner, relative to the measuring scale. The measuring scale and also the sensor are thus not subjected to any mechanical wear. In addition parallelism in terms of guidance of the sensor relative to the direction of travel of the measuring scale only has to be limitedly implemented.

In particular the spacing between the sensor and the measuring scale, which should be about 1.0 mm, may also alter somewhat.

In that respect a separate reference track which primarily carries only the (singular) reference mark, by virtue of defined magnetisation also over the remainder of its length, can contribute to the device still being capable of managing with a somewhat larger spacing between the sensor and the measuring scale. That is possible in particular insofar as the (analog) output voltage of the reference sensor is no longer evaluated in accordance with its amplitude but in accordance with its sign, for example by means of an amplitude discriminator with a switching threshold of 0 volt or the mean value of the analog reference voltage.

The electronic system for evaluation of the measurement signals includes on the one hand a converter for converting the periodic analog signal, for example a sinusoidal oscillation, into a periodic digital signal, for example a rectangular signal.

In that respect a sinusoidal signal does not necessarily have to correspond to a rectangular signal; as the form of the analog signal is known, the relative position in the measuring direction can be ascertained within a period of the analog signal by relatively accurate evaluation of the analog signal, for example the instantaneous absolute value. An interpolator, generally in the form of an electronic circuit, for example on the basis of the previously described methods, provides that the for example periodic digital signal obtained does not have smaller pitch spacings than the for example periodic analog output signal, that is to say the level of resolution of the digital signal is substantially higher. In that respect, the factor of the higher level of resolution can be adjusted at the interpolator and, if the interpolator is in the form of a programmable circuit, can be adjusted by means of re-programming or a change in programming.

In general in that respect the converter is integrated in the interpolator in terms of circuitry and/or physically.

Likewise further parameters, for example correction factors for correction of the characteristics of the electronic system, correction factors for adjusting the zero point and/or gain of the electronic system or individual structural groups of the electronic system, correction factors for adjusting the position of the reference point within a pitch of the measuring scale can also be adjusted at the interpolator and in particular re- programmed.

The electronic system also includes a line driver circuit which as usual serves to improve the transmission capability of the output signal, for example by reducing the impedances.

The electronic system further includes a protective circuit which protects the entire electronic system or at least parts thereof from excessively high voltages and/or excessively high currents, as can occur for example by virtue of incorrect polarity at the output unit.

In general the electronic system, at its peripheral connections to the environment, in the conductor tracks, has internal node points which are connected to the electronic components of the electronic system, and external node points which are connected to the connecting cable of the output unit, the power supply and all further contact points which are accessible from the exterior, for example of the contacting unit, for programming the interpolator.

In that case the protective circuit is between the internal and external node points and in the present case can certainly be a structural component of the interpolator and/or the line driver circuit.

The protective circuit, a part of the protective circuit or also voltage regulators, interpolators and line drivers can be disposed in the housing of the connecting plug (=output unit) of the sensor.

The protective circuit provides for limiting the electrical currents in the conductors to and from the electronic system and provides for carrying away excessively high voltages in those conductors, for example by virtue of using current-limiting impedances (ohmic resistors or frequency- dependently absorptive by ferrite chokes, frequency-dependently reflective due to inductances or current-dependent due to PTC-resistors or integrated as current-dependent limitation means in the output stage of the power driver) and/or voltage-limiting components (for example captiodes, in particular integrated in the line driver, by-pass diodes, varistors).

For, under some circumstances, line-related interference voltages can penetrate from the output side, that is to say by way of the output unit, over a wide frequency and amplitude range and can reach the sensor unit. In that case, with its current- and/or voltage-limiting components, the protective circuit affords protection on the one hand from destruction of parts of the electronic system by in particular pulsed currents and/or overvoltages involving high amplitudes, while on the other hand, by means of the absorptively/reflectively and frequency-dependently filtering components, it provides protection from impairment of measuring accuracy and operational reliability of the electronics of the sensor unit by in particular high-frequency interference voltages. A further advantage of the protective circuit is also that, instead of expensive screened cables, it is also possible to use simpler and even unscreened cables.

The electronic system further includes an output unit in order to be able to output that digital and generally high-resolution signal, either to a display unit, for example a digital display, or for further processing to a machine control.

In general, for that purpose, fixedly arranged on the sensor unit is a cable, at the end of which is arranged a plug as the output unit.

So that such a measuring device can be used with maximum versatility on widely differing machines and installations, besides the highest possible level of insensitivity in relation to physical and chemical influencing factors, a further aim is to provide for the smallest possible structural dimensioning both of the measuring scale and also the sensor unit.

In that respect the measuring scale generally comprises a magnetic band of a thickness of between 1 and 2 mm and about 1 cm in width, which is flexible and which is glued by means of a self-adhesive coating or a double adhesive band directly on a machine but also on a profile bar which permits sufficient flatness, and is covered as mechanical protection by a high-quality steel plate which is non-magnetisable.

The important consideration in regard to the sensor unit is in particular a small structural height. More especially the sensor unit should not be wider than the measuring scale. The sensor unit should also not project in the measuring direction unlimitedly beyond the position of the actual sensor which is generally very short in the measuring direction and only a few millimeters long, as such a projection configuration in fact requires the measuring scale to be overlength over the distance to be measured.

In contrast the extent of the sensor unit in a direction perpendicularly to the plane of the measuring scale is less critical.

In that respect it is usual for the parts arranged in the movable sensor unit, in particular the parts arranged therein of the electronic system, to be protected by a surrounding fixed housing and/or by being embedded in plastic material.

If the factor by which the digital signal had a higher level of resolution than the basic analog signal, that is to say the pitch division of the measuring scale, should be subsequently adjustable, for example by means of programming, which is necessary in particular when using one and the same length measuring device for different purposes of use, the corresponding interpolator was hitherto not disposed within the movable sensor unit, but arranged as a separate structural group remote from the sensor unit, so that the signals obtained by the sensor unit were converted by means of cable and plug in that separate interpolator.

One of the disadvantages of the state of the art is that the reference track, over the substantial part of the length thereof, is non-magnetised or is homogeneously magnetised in single-pole mode or is provided with a very short regular magnetic period so that the reference sensor evaluates those magnetisation effects as non-magnetised or as homogeneously magnetised and delivers a constant dc voltage of zero (in the case of the non-magnetised reference zero) or different from zero (in the case of single-pole homogeneous magnetisation).

At the position of the reference marking, the homogeneous configuration of the reference track is interrupted by an individually provided magnetic pole or also by stamping out the magnetic material at that location (DE 20011703U1). At that location the reference sensor produces a singular analog signal which is evaluated by presetting a threshold value.

The amplitude height of the analog reference signal decreases greatly with the increase in the guide spacing (spacing between sensor and measuring scale) and therefore greatly limits the tolerance range thereof. In contrast the sine/cosine signals of the position sensor, by virtue of evaluation in accordance with their magnitude relationship (ratiometric evaluation), are less dependent on fluctuations in the amplitude height. The guide tolerance range of the sensor system is therefore determined in particular by the amplitude dependency of the reference signal.

A further disadvantage of the state of the art is also that a separate track is required, having regard to the width of the plurality of juxtaposed tracks of the measuring scale, solely for a reference mark such as for example the zero point mark. If therefore the measuring scale contains only a single counting track with detectable codings which can be counted in the measuring direction, a second track is required solely for the reference mark, and that therefore requires a doubling of the width of the measuring scale.

In order to achieve a compact structure, that is to say a reduction in the width of the measuring scale and also the sensor unit, the aim is to forego a separate reference track.

A further aim is to provide that the reference sensor operates reliably over the same tolerance range in respect of the guide spacing as the position sensor.

### III. STATEMENT OF THE INVENTION

a) Technical Object

Taking that situation as its basis, the object in accordance with the invention is that of providing a measuring device which in spite of adjustability in particular of its resolution is small and compact and nonetheless operationally reliable.

b) Attainment of the Object

That object is attained by the features of claims 1, 2, 13, 22, 34 and 48. Advantageous embodiments are set forth in the appendant claims.

By virtue of the arrangement of the interpolator directly in the sensor unit which is movable relative to the measuring scale, the sensor unit can be connected to a machine control or a digital display by means of cable, in spite of adjustability of the resolution factor, directly and without the interposition of a separate structural group, with the interpolator. The space required for the length measuring device within an underlying machine or the like is also thereby drastically reduced.

Independently thereof, the aim that the invention seeks to achieve in regard to the size of the sensor unit is that the sensor unit is no wider than the width of the measuring scale and the length of the sensor unit as measured in the measuring direction is no greater than 50 of the smallest increments of the measuring scale, in particular no greater than 5 cm, in particular no greater than 3 cm.

The height of the sensor, calculated in the perpendicular to the measuring direction and the transverse direction thereof, that is to say the plane of the measuring scale, should be no greater than the length thereof.

In addition the adjustable factors of the interpolator are still adjustable even after finished assembly of the sensor unit—that is to say after insertion into and fixing in, in particular by casting material therearound, the wired electronic system in the sensor unit, with the contacting unit still being accessible—by the contact points of its contacting unit still being accessible.

When teeming material around the sensor unit—which is effected with or without a surrounding housing—that is effected either in that the contact points of the contacting unit project from the teeming material, or, with a surrounding housing, lie outside the teeming material but still within the housing or—when the sensor unit is completely enclosed by the teeming material—it is still possible to access the contact points by inserting needle-shaped contact pins through the enclosure. Preferably in that case a teeming material is selected, which even after hardening is still elastic and in particular plastic, so that the openings formed by puncturing insertion of the contact pins subsequently automatically close again.

In that respect the properties involved, in particular the physical properties, of the casting material used, are selected to be different according to the respective position within the sensor unit, and in particular a portion-wise, multi-stage casting operation can be effected:

Thus for example the lower region near the front face of the sensor unit in which the sensors are disposed can be teemed or cast with a harder teeming material in order to provide optimum protection for the sensors from mechanical damage.

The further upwardly disposed teeming effect which extends further towards the rear side of the sensor and which in particular extends to and including the rear side of the sensor can in contrast be carried out using a softer, more elastic, possibly even plastic teeming material in order still to permit piercing of the teeming material with contact needles to the desired contact surfaces, even when the material is in the hardened condition.

In general terms, the principle which applies in that respect is that the teeming material must be so elastically selected that shrinkage which always occurs upon hardening does not damage the electronic system and the components thereof, that is to say in particular does not tear same away from the circuit board, and on the other hand the teeming effect at the respective locations is to be as hard as possible in order to ensure the mechanical protection necessary for the respective elements.

A middle-way solution provides that, when casting material around the electronic system, in particular when there is no surrounding housing, contact openings are retained from the outside of the teeming material as far as the contact points of the contacting unit of the interpolator. That is possible in the simplest fashion in that the mold into which the circuit board on which the electronic system is arranged is inserted for surrounding it with teeming material has the pin-shaped supports which project from the mold towards the circuit board at the positions at which later the contact openings to the contact points are wanted.

It is equally also possible to envisage accessibility to the interpolator for the purposes of adjustability by way of the electrical conductors of the output unit, that is to say the outgoing cable, but this generally increases the number of wires and diameter thereof, and thus reduces the flexibility thereof. The advantage is that from the outset complete teeming of material around the electronic system is possible and no contacting unit has to be left free.

In order also to dispose the interpolator in the restricted sensor unit, at least the interpolator and thus also the converter is in the form of an integrated circuit (chip) and likewise the sensor which detects the magnetic field of the measuring scale.

The electronic system (9) preferably also has an EPROM, in particular an EEPROM, for intermediate storage of the data processing program for the first chip (4) and/or the second chip (5) and/or for the intermediate storage of signal values.

At least that sensor chip of which there can also be a plurality—depending on the number of tracks on the measuring scale—, and in particular all chips, are preferably arranged in the form of a non-housed, bare chip, onboard on the circuit board.

Preferably in that respect the circuit board is arranged in a direction parallel to the measuring direction within the sensor unit, but not parallel to the plane of the measuring scale. Preferably, the electronic system disposed in the sensor unit is not arranged on one but distributed on a plurality of boards. Those fixed boards are already connected prior to assembly of the sensor unit by way of flexible lines, in particular by way of flexible boards with conductor tracks, or they are formed in one piece with each other, wherein preferably the number of fixed boards corresponds to the number of measuring scale tracks to be sensed, so that a respective sensor, preferably in the form of a bare chip, is arranged at the front edge of each of the boards, in particular on the longitudinal center thereof.

In regard to the teeming or casting procedure, care is to be taken to ensure that the sensors and boards are still covered by a thin layer of teeming material, at the front side of the sensor unit.

If the electronic system is arranged within the sensor unit only on a single fixed board and nonetheless a plurality of sensors are required by virtue of the measuring scale having a plurality of tracks to be sensed, that board can be arranged within the sensor unit at an acute angle relative to the measuring direction, that is to say slightly inclined, so that the plurality of sensors arranged along that inclined front edge are then respectively disposed in the width of their track on the measuring scale when the sensor unit is guided overall centrally with respect to the measuring scale in the lengthwise direction, in which respect in fact the width of the sensor unit does not have to be exactly identical to the width of the measuring scale but for example can be slightly narrower.

Depending on whether an incremental or an absolute measuring system is required, the measuring scales have a different number of tracks. In the simplest case, the incremental measuring system, a track with uniformly alternating magnetisation is sufficient, with a second track as a reference track on which, in the simplest case, a single mark as a reference mark or a change between two marks is sufficient, at a single lengthwise position on the measuring scale.

In that case, two digital, for example rectangular signals are produced from the one incremental track which in the sensor produces an analog sinusoidal signal, wherein the two digital signals are in phase-shifted relationship with each other—through a phase shift which differs from half a phase—through for example 90°, so that it is possible to detect the direction of travel of the sensor unit on the basis of the phase shift and sensing of both digital signals. In addition, to avoid interference effects, the two digital signals are communicated a second time in respectively inverted form.

The reference mark which is normally guided on a separate reference track beside the normal counting track—as it only has to be present at a single lengthwise position—can also be in the form of a track which is not continuous over the total length, but can be provided only physically at one single location. That affords the user of the measuring device the possibility of selecting the longitudinal position at which the reference mark is disposed, which must firstly be traversed each time before the measuring device is brought into operation. That is appropriate for example if for other reasons, when switching off the measuring device, the sensor unit or the component carrying it is moved each time into a given one of the two end positions. It is then appropriate for the reference mark also to be arranged near that end mark.

Another possibility—in order to save on the track width of the reference mark—involves integrating the reference mark into the periodic marking of the normal incremental tracks of the measuring scale, for example in the form of a special signal, in which the north/south magnetisation is provided at that location for example with a higher or lower level of field strength, or is of a different length in the measuring direction, which can be detected by the electronic evaluation system, or the like.

The omission of a separate reference track is made possible insofar as the one or more reference marks are integrated into the normal counting track. The magnetic coding along the counting track has a pattern which is regular in accordance with any algorithm:

In the normal case the measuring scale comprises regions which are each of equal length and which are magnetised alternately through 180 in each case in mutual succession and whose north/south magnetisation axis is disposed transversely with respect to the longitudinal direction so that a South pole and a North pole of such a coding are always arranged alternately along one of the longitudinal edges of the measuring scale.

Integration of the reference mark into the counting track is effected in that this regular sequence of codings is replaced at a location by an irregular sequence, that is to say for example in the case of the above-described alternate north-south arrangement, two or also more identical arrangements occur in succession.

That can be achieved for example in that, with an alternate north-south coding, at least one and in particular precisely one of the magnetised codings is subsequently modified with the consequence that at that location, in the longitudinal direction, at least three identically oriented codings then follow each other, that is to say the coding is of a length which is then at least treble the normal length.

A sensor in the sensor unit which—for reasons of measuring accuracy—is generally to detect each individual coding when passing thereover will normally deliver a modified signal which harms the measurement result, by virtue of that irregularity.

In order to avoid this, it is possible to proceed in different ways:

The one solution provides arranging the reference mark outside the normal measuring region of the measuring scale, that is to say arranging at the desired measuring length L1 of the measuring scale in which the counting track is regularly coded and reliable measurement is possible, at at least one end, a projection portion L2—preferably disposed on the same counting track—and positioning the reference mark in that projection portion, preferably directly after the end of the normal measuring length L1. That however increases the overall length of the measuring scale with respect to the necessary measuring length, but it does afford the possibility of using sensors of the same structure within the sensor unit both as a position sensor and also as a reference sensor.

That is possible when, when the sensor unit goes to an end of the measuring scale provided with the reference mark, within the sensor unit, the reference sensor is arranged upstream of the position sensor in the direction of travel, that is to say the reference sensor first reaches the reference mark. As a result the position sensor does not reach or pass over the reference mark and the direction of movement of the sensor unit can still be altered before reaching the end of the normal measuring length L1.

Another possibility involves so designing the sensor unit that, when the reference mark is arranged within the measuring length, the irregular coding at the location of the reference mark does not result in an incorrect result.

For that purpose, either the electronic evaluation system can be suitably designed, or, arranged in the sensor unit, for sensing the counting track which also includes the reference mark, besides the position sensor whose function is counting the codings of the measuring scale as they pass, is a separate reference sensor spaced in the longitudinal direction relative to the position sensor and thus sensing the same counting track.

By virtue of a different configuration of the reference sensor and the position sensor, it can be provided that, on passing over the irregular coding, in the region of the reference mark, the position sensor nonetheless continues to count normally, corresponding to the travel length covered, while the reference sensor detects the irregular coding as the reference mark and accordingly delivers a reference signal.

As already mentioned, the same kind of sensor can be used as the position sensor and the reference sensor if the evaluation circuits thereof are of a correspondingly different design configuration for recognising or ignoring the reference mark. Also, combining the reference sensor and the position sensor in the form of a single sensor and alternately different operation of that for example only one sensor by means of a differing evaluation program can lead to the same result.

In that respect, it is also immaterial whether and how greatly interpolation of the analog signal period, which is possibly effected by an interpolator of the electronic evaluation system, is upon conversion into a binary signal. If such an interpolation operation is effected, in which for example an analog sine-cosine signal period is subdivided into 200 binary signal periods (for example rectangular signals), then a relative index signal is produced in the binary interpolated signal sequence at a given location in the analog signal period, for example at the zero passage from the negative to the positive side, in order to characterise the relative position of the binary signals within the analog signal periods.

Absolute referencing which is intended by the reference marking on the counting track is however independent thereof.

That absolute referencing can either serve the purpose of defining an absolute zero position on the measuring scale or characterising the end of the measuring region of the measuring scale, or it can also serve other purposes.

Preferably, in the course of processing of those reference signals, a guide error procedure is also implemented, which delivers a specific warning signal if the distance between the sensor unit and the measuring scale becomes too great and thus reliable detection of the codings of the measuring scale by the sensor unit is endangered.

When the position sensor and the reference sensor are of different configurations, one possibility is that the two sensors respectively detect different lengthwise regions of the measuring scale:

Thus for example the reference sensor can only detect the length of a single coding of the measuring scale while the position sensor covers and also detects a length of for example four such codings and as the analog signal outputs a hybrid value of those for example four codings, that is to say outputs the mean value thereof.

When the sensor unit passes over a reference marking which for example comprises two successive identical codings, the mean value-formation procedure provides that the analog signal produced will be of the same positive or negative orientation or amplitude, over the entire region of the reference mark. By means of the reference sensor which detects the only one single coding however it is possible, in spite of the progress in the measuring direction, to establish the coding which remains the same a plurality of times and thus to detect the reference mark as for example exactly in the middle between the for example two successive identical codings of the measuring scale.

If the described marking with two successive identical codings involved a zero point mark, a measuring scale end mark can be embodied by more than two successive identical codings of the measuring scale, in particular a number of identical successive codings which is equal to or greater than the number of codings which are simultaneously detected or covered by the position sensor.

In order to be able to keep the projection portion on the measuring scale short when arranging measuring scale end marks, a respective reference sensor can be arranged in the sensor unit on both sides of the position sensor, in that case once again at an exactly known spacing which is defined in relation thereto, so that the end mark is already detected by the reference sensor before being reached by the position sensor and thus the machine or structural group monitored thereby can be stopped in good time.

In particular the position sensor and the reference sensor can be arranged on the same chip of the sensor unit.

In order to detect the irregular coding sequence in the region of the reference mark, in general logical linking of the signals of the position sensor and the reference sensor is carried out, either in respect of the analog signals thereof, for example by subtraction of the signals of the reference sensor and the position sensor and subsequent threshold evaluation, or by comparison of the binary signals thereof by logical linking.

When there is more than one reference sensor, the outputs thereof are preferably connected in parallel and thereby a mean value is produced as the output signal of the two reference sensors. Particularly if the analog output signal of the position sensor is subtracted in weighted form therefrom, that results in a regular analog, in particular sinusoidal reference signal, when passing over regular coding regions. It is only upon passing over the reference mark that one of the reference signals is inverted and therewith also the mean value thereof, whereby the analog end signal is also influenced.

The advantage of disposing the reference mark in the counting track, that is to say the normal codings of the counting track, lies not only in the narrower design configuration of the measuring scale and the sensor unit, but also in the possibility of subsequently applying the reference mark:

Thus a regularly coded, in particular magnetised scale can be obtained by cutting to length a band produced endlessly in that way, and positioning it and fixing it on the desired component for example of a machine. Application of the reference mark is effected by subsequently re-magnetising at least one of the magnetic codings on the scale, with a magnetisation head which is stronger in relation to the magnetisation in the measuring scale, which for example can also be a strong permanent magnet, for example a neodymium-iron-boron magnet. For establishing the reference mark, it is also possible to use the sensor unit which is already mounted to the machine to be monitored and to which that magnetisation head can be fixed and can then be moved for example by means of the control system of the machine into a position which for example coincides with the programmed zero point of the machine control system. Subsequent displacement or the additional application of reference marks, whether as zero point marks or as measuring scale end marks, is also possible, which for example is necessary when the regular working range of the machine is altered by virtue of structural conversion or the fitting of additional machine components.

As the reference sensor no longer evaluates a homogeneously magnetised track but a track which is periodically alternately magnetised, with a suitable magnetic period, the analog reference signal, like the position signal, is now a sinusoidal signal with positively and negatively identical amplitudes symmetrically with respect to its mean value. In that respect it is advantageous that it is not the amplitude but the phase position which can be evaluated over a wide amplitude range, that is crucial in terms of evaluation. That ensures that the tolerance range for the guide spacing of the sensor system is no longer limited predominantly by the reference sensor. A regularly magnetised track with integrated reference mark can also be in the form of a separate reference track, if the position track is to remain undisturbed.

c) Embodiments

Embodiments of the invention are described in greater detail hereinafter. In the drawing:

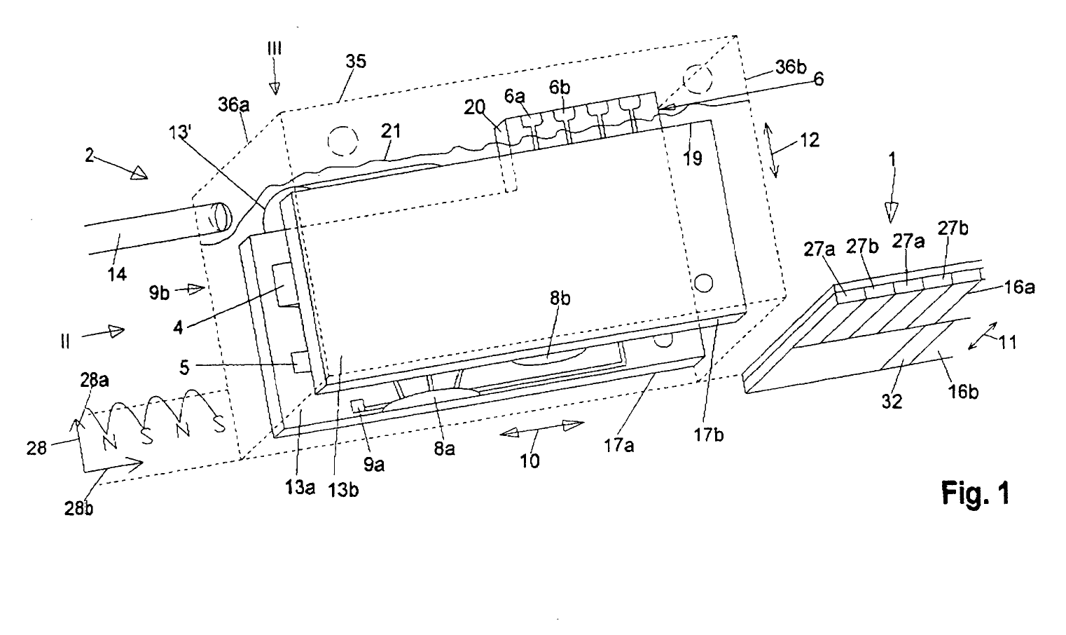

FIG. 1 is a perspective view of a sensor unit 2 and a measuring scale 1,

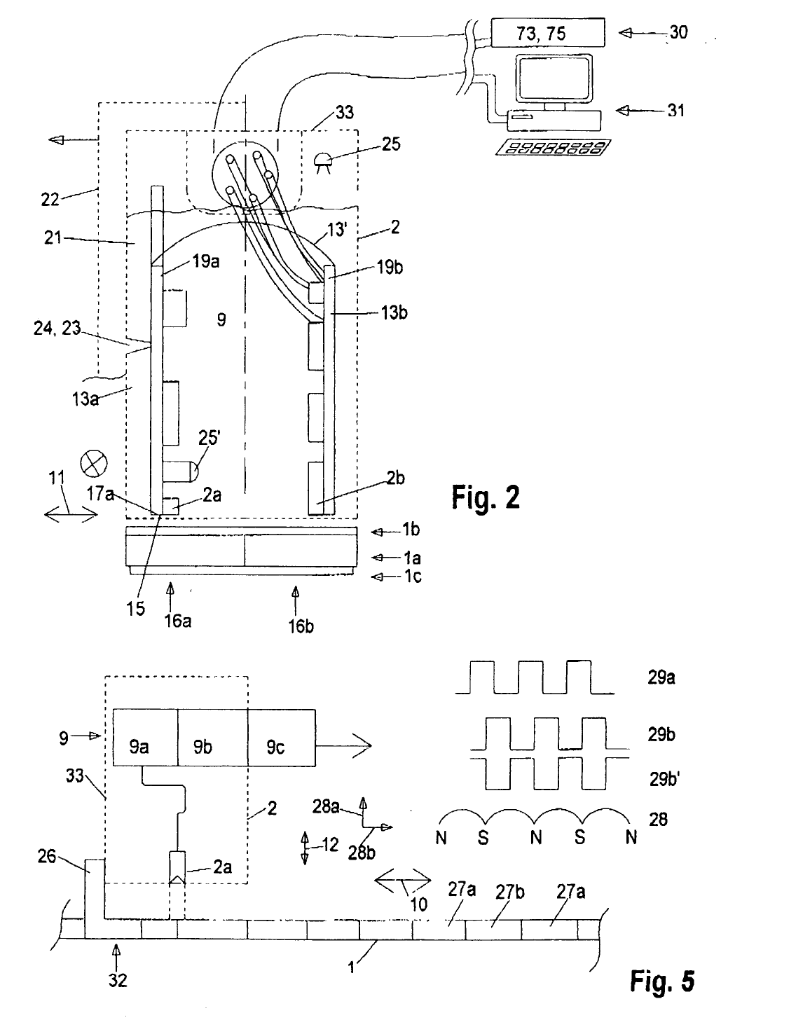

FIG. 2 is a view of the arrangement of FIG. 1 looking in the direction II,

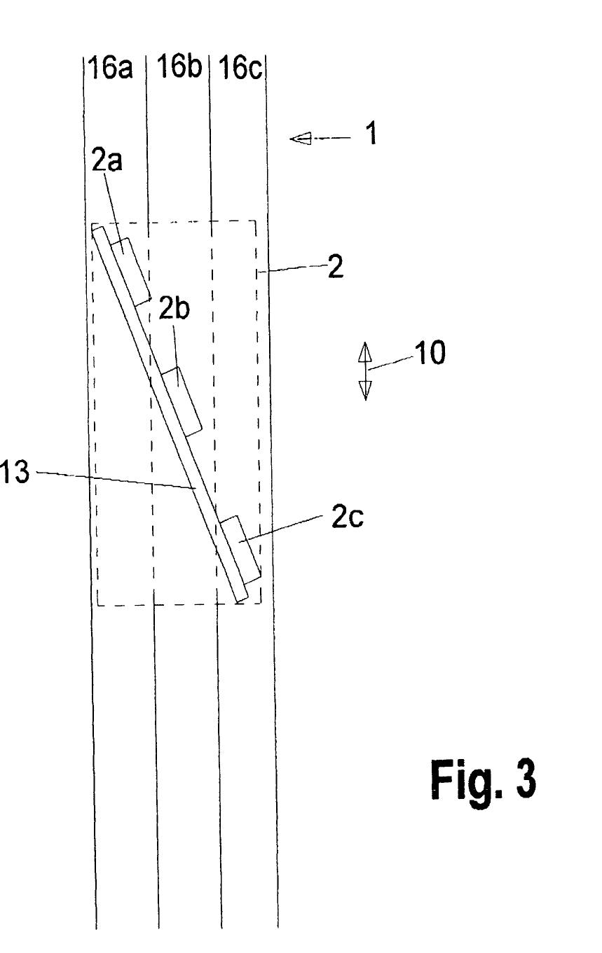

FIG. 3 shows an arrangement which is modified in relation to FIG. 1 looking in the direction II in FIG. 1,

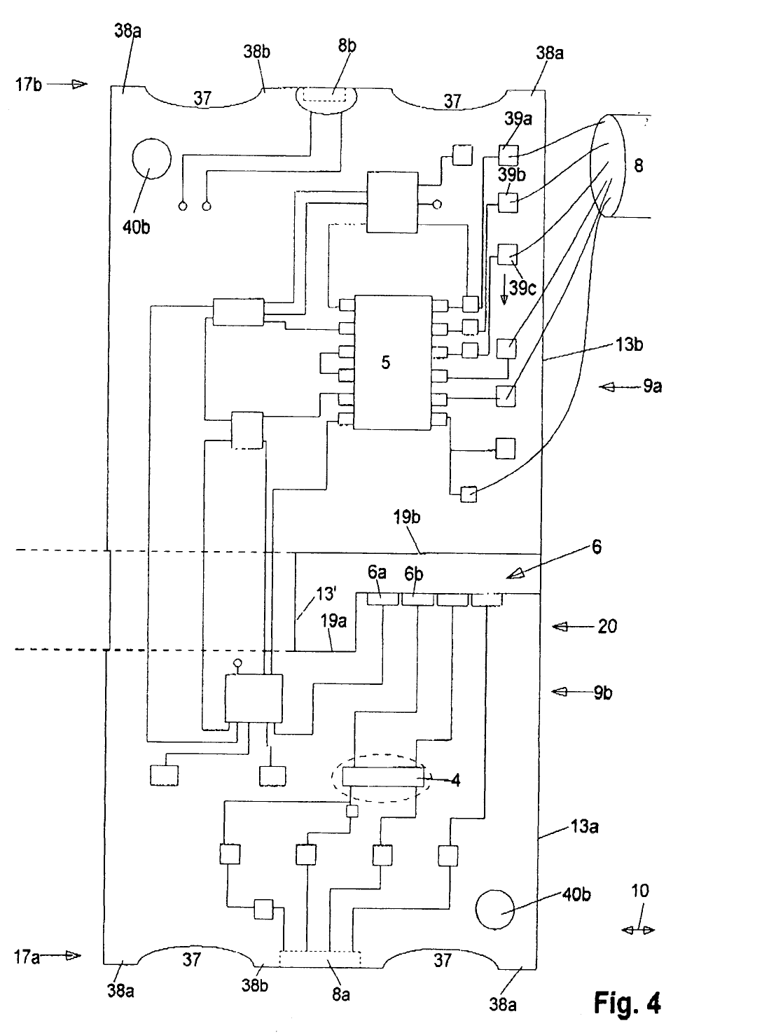

FIG. 4 shows the boards (13) of FIG. 1,

FIG. 5 is a diagrammatic view showing the components of the device,

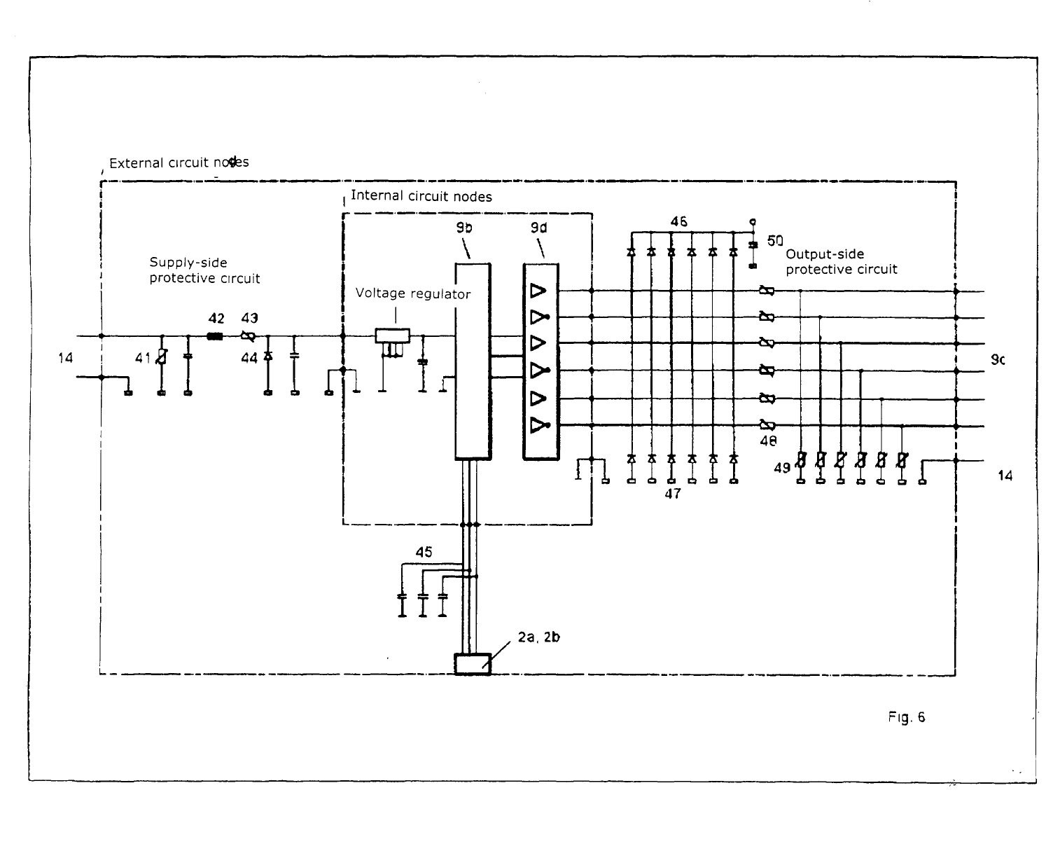

FIG. 6 is a circuit diagram showing the principle of a protective circuit,

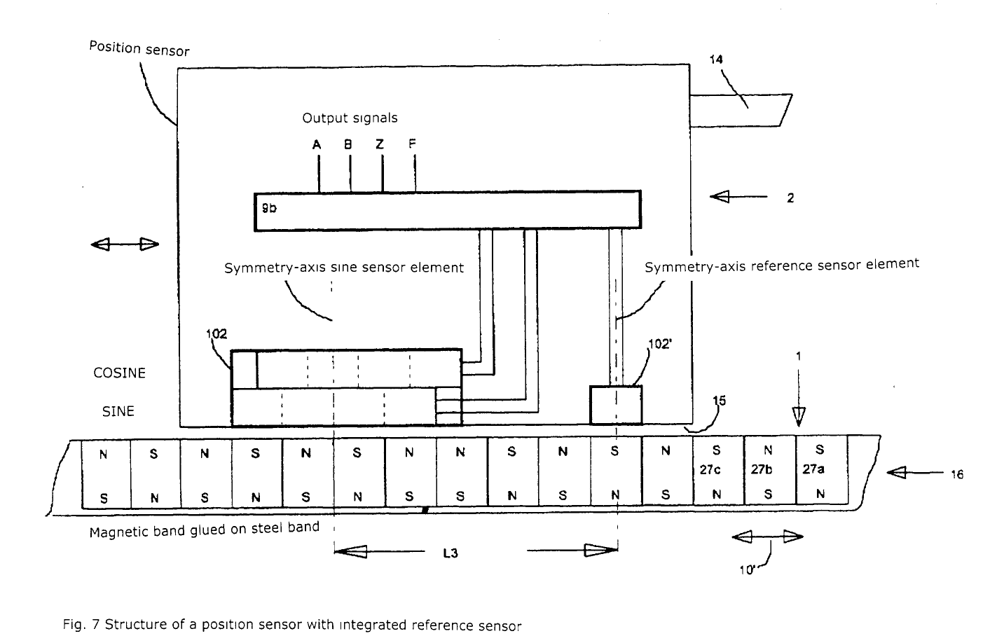

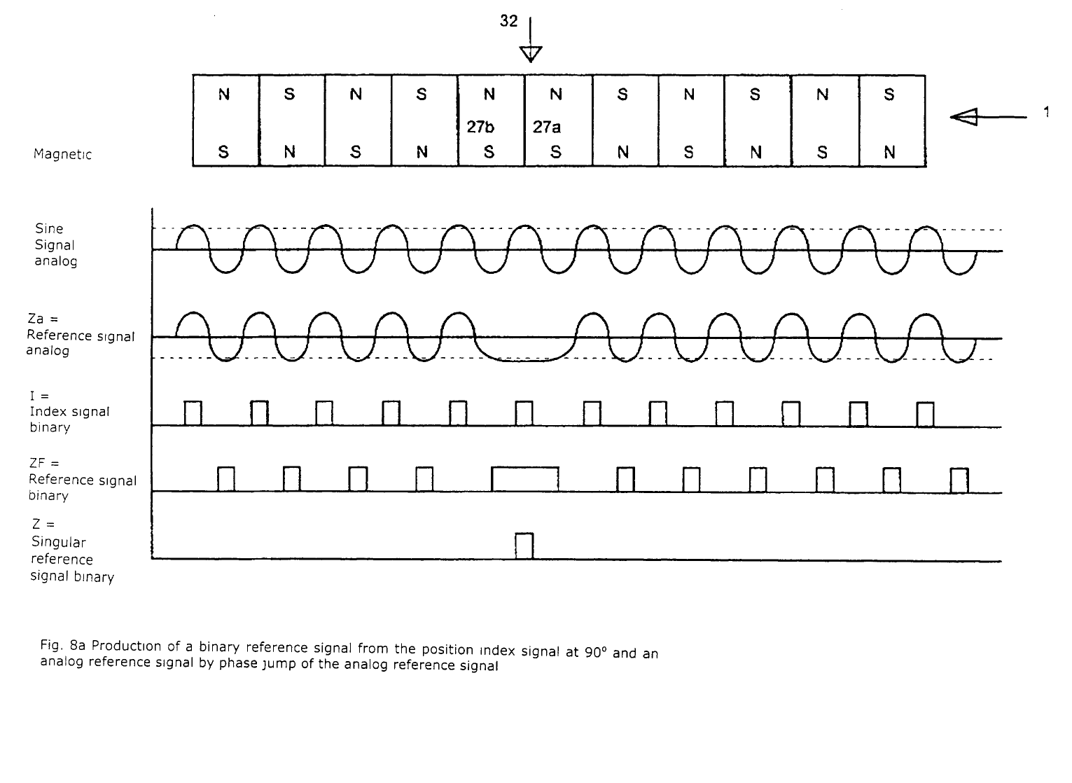

FIG. 7 is a diagrammatic view of a sensor unit 2 and a measuring scale 1 with only one track,

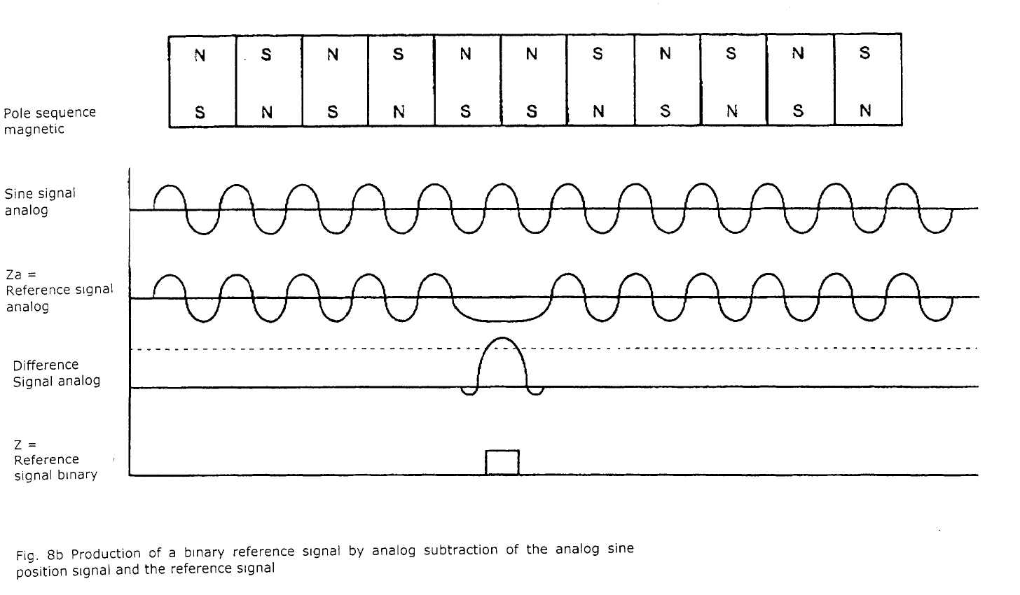

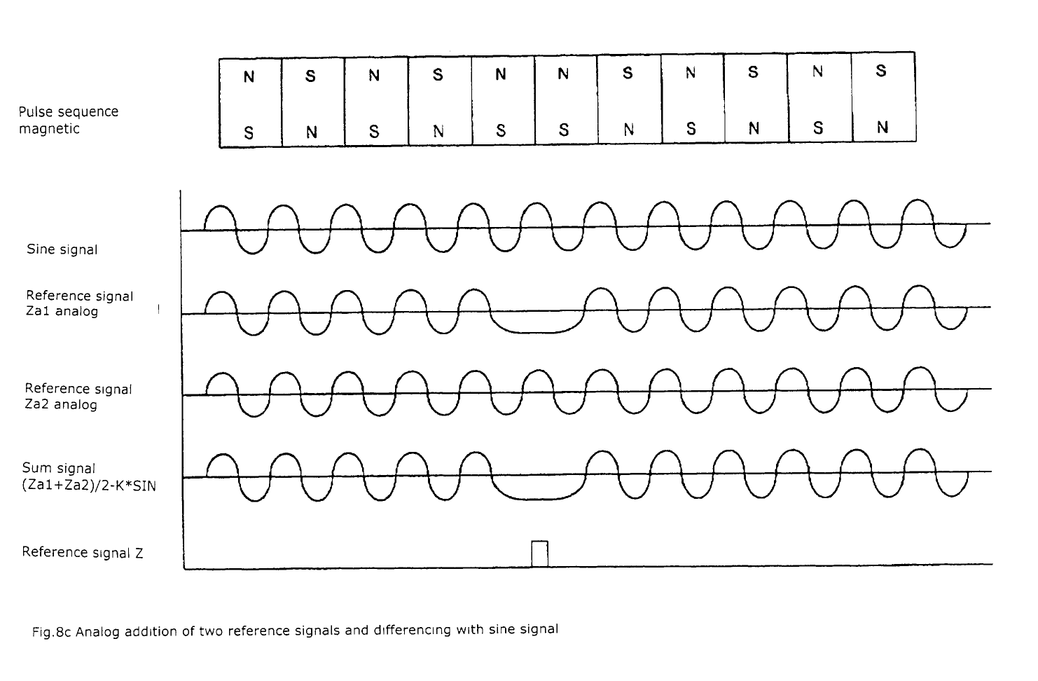

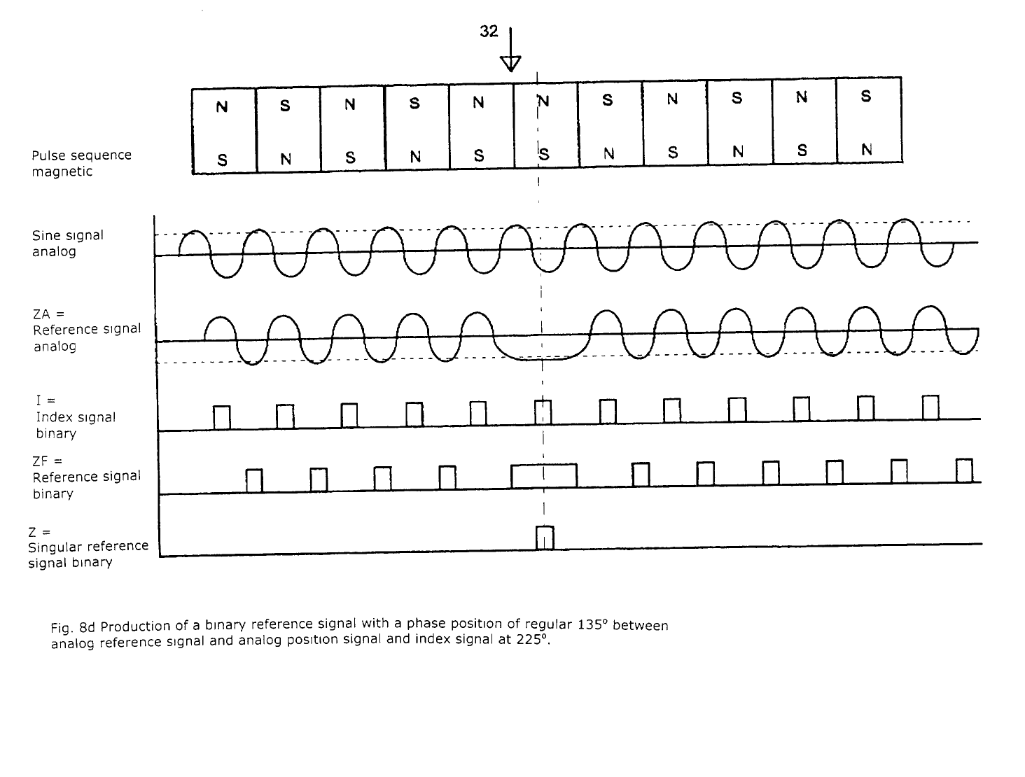

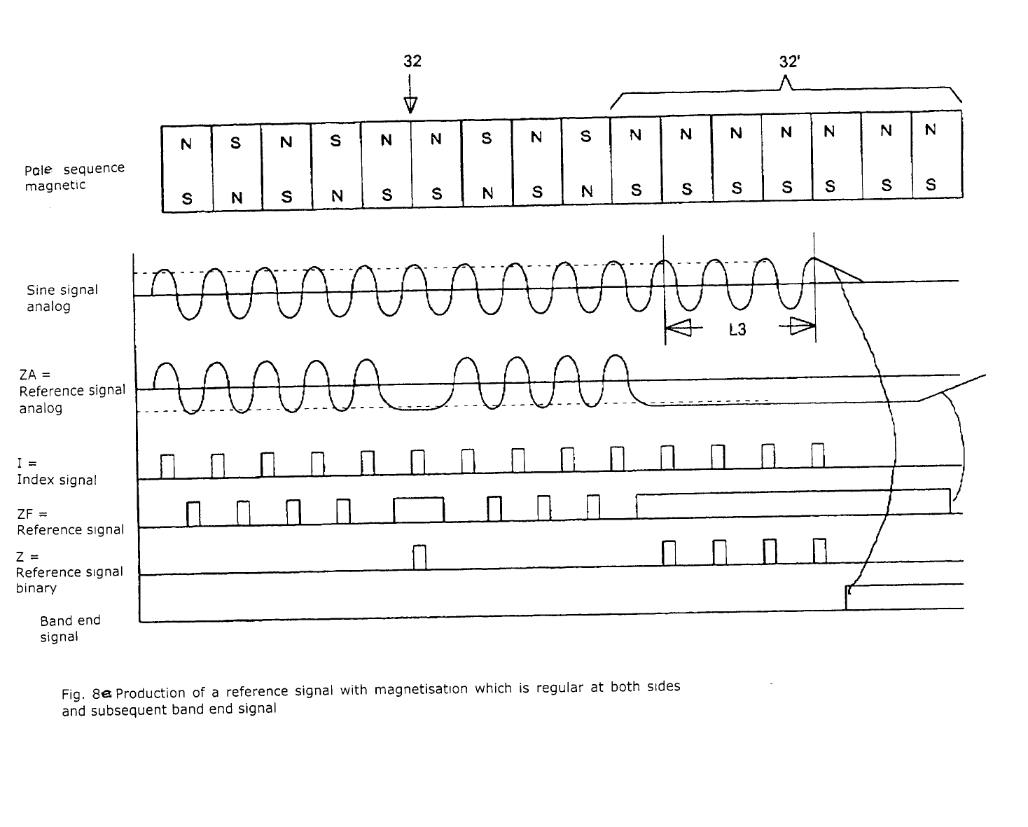

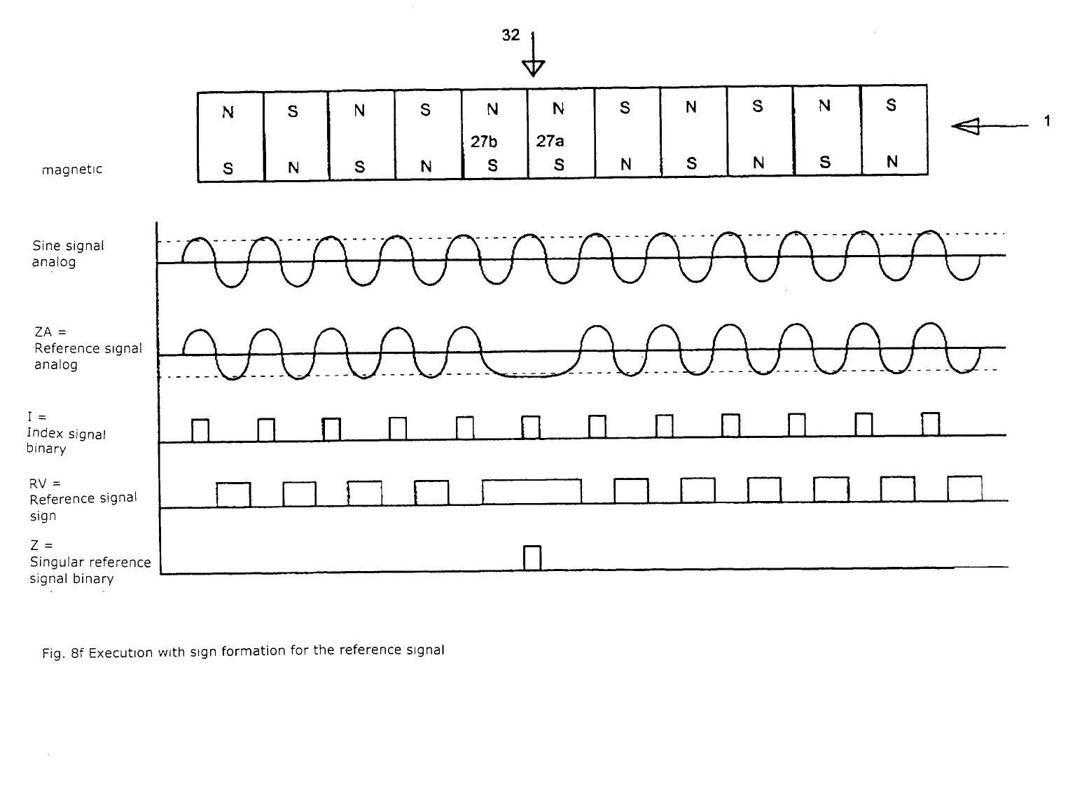

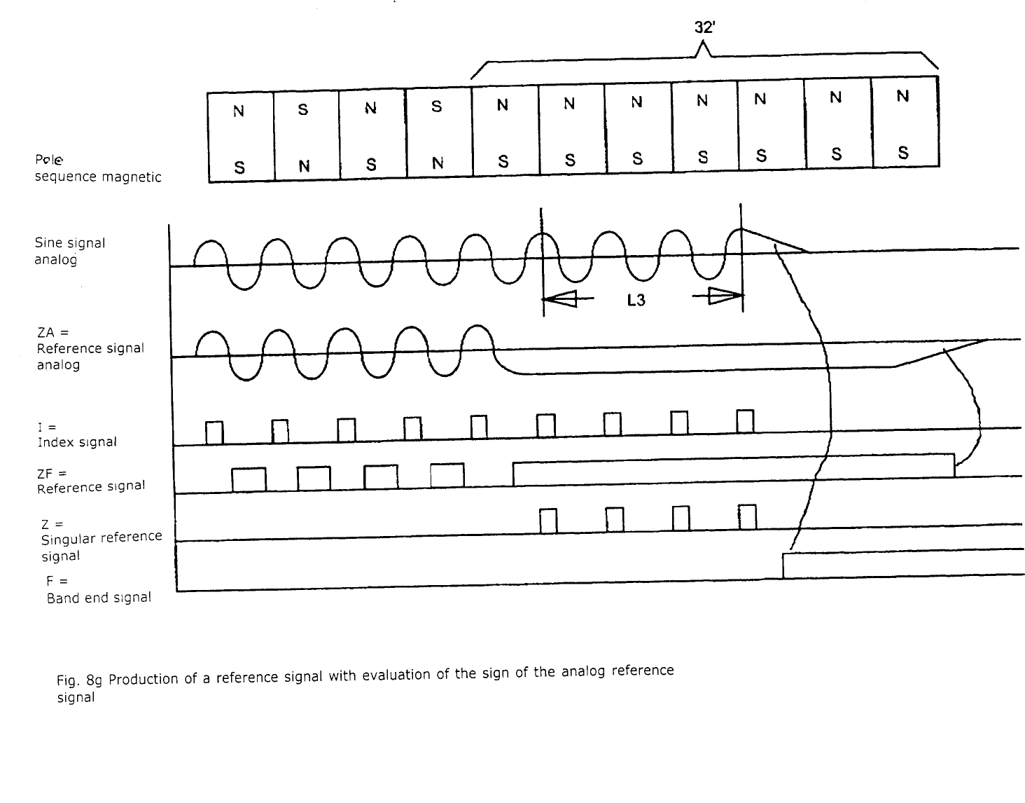

FIGS. 8 show the stages in signal conversion to a binary reference signal,

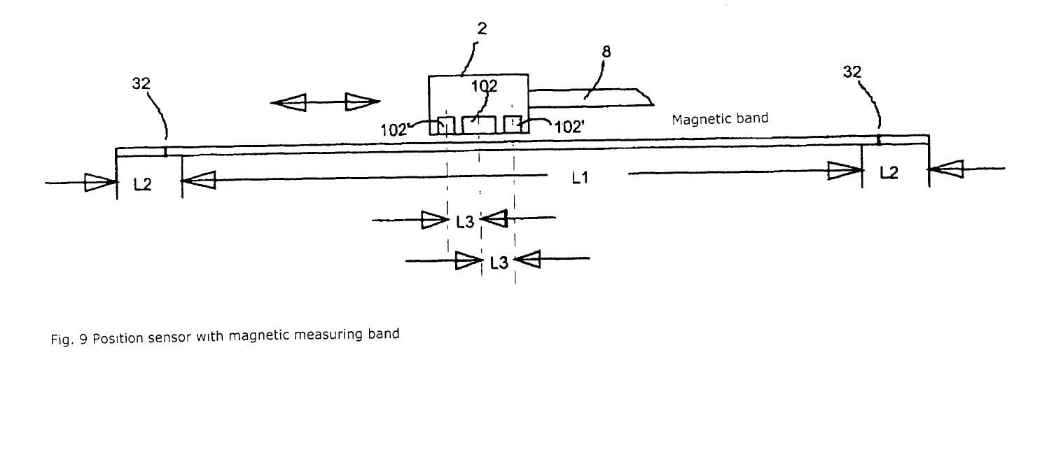

FIG. 9 is a diagrammatic view of a prolonged measuring scale, and

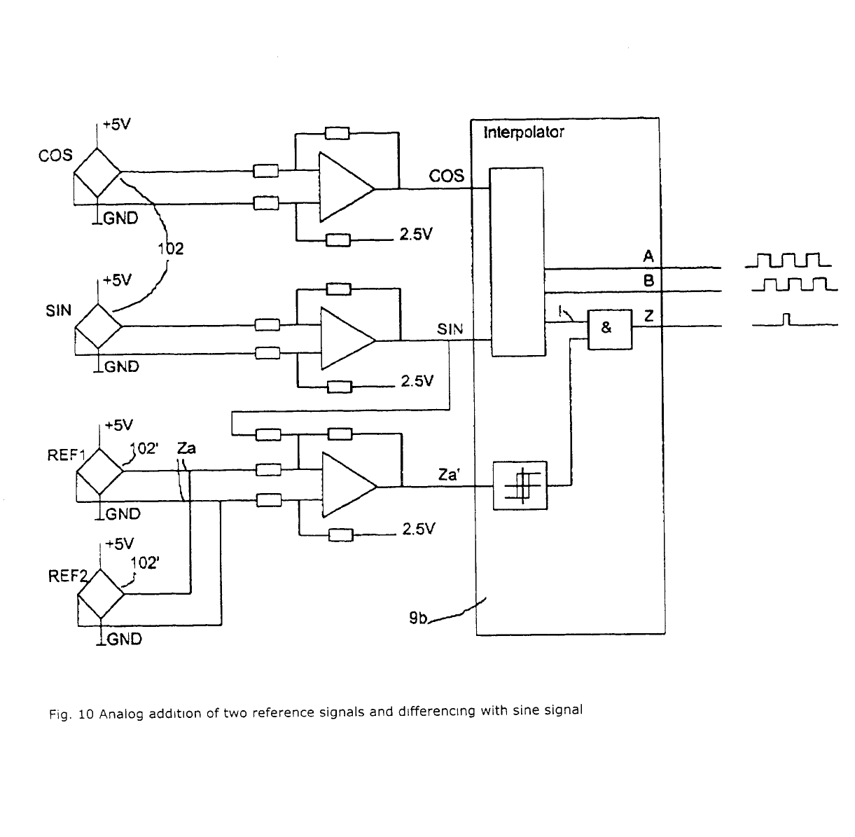

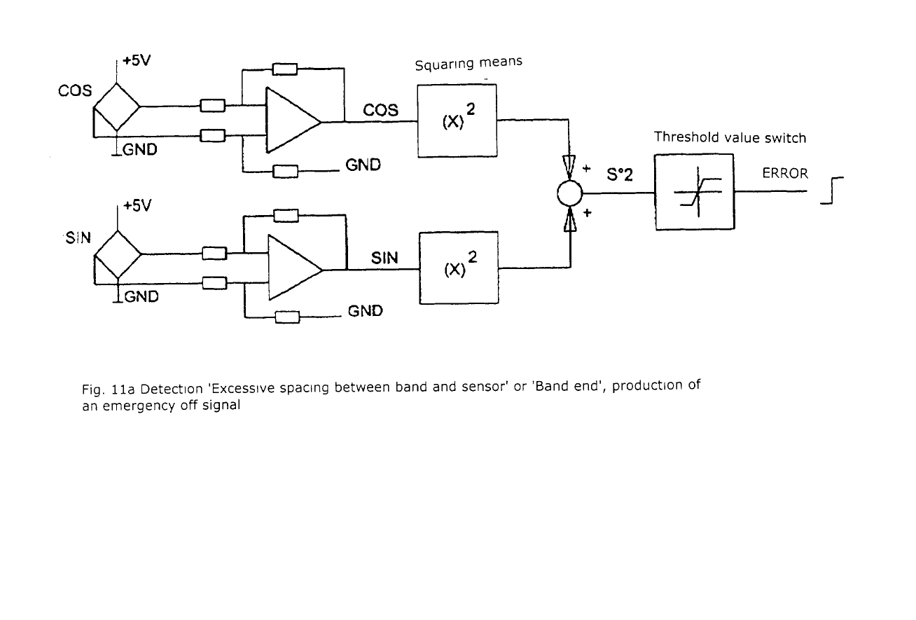

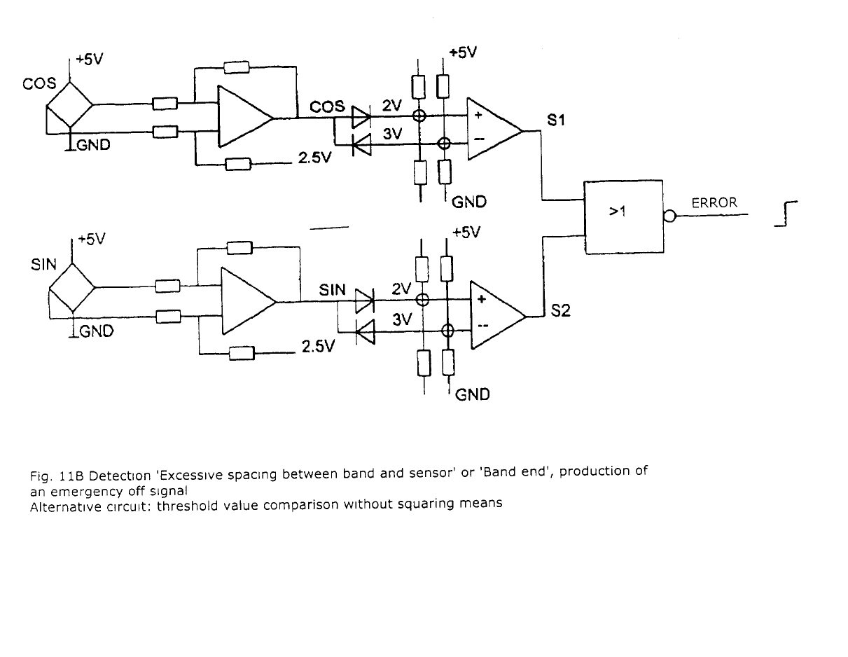

FIG. 10 and FIG. 11 show circuits by way of example for producing the desired output signals.

As can be seen from FIG. 5, the length measuring device comprises on the one hand the measuring scale 1, the movable sensor 2a and an electronic evaluation system 9 as the sensor 2a, when sliding thereover in the measuring direction 10, detects the segments 27a, 27b which follow each other in succession in that measuring direction 10 and which are magnetised differently and which for example are magnetised alternately as North and South poles and which in particular are of equal length, as an analog sinusoidal signal 28 or in particular as a sine-like analog signal which only comprises positive sine half-oscillations, the electronic system includes on the one hand a converter 9a for converting that periodic analog signal into a periodic digital signal.

The electronic system further includes an interpolator 9b which can also be constructed together with the converter 9a in a structural group and thus as a unitary circuit, and which provides that the periodic digital signal has a higher level of resolution than the underlying periodic analog signal, that is to say the period spacings of the digital signal are shorter in particular by a multiple and in particular by more than the factor 10 and in particular by more than the factor 100 than the period spacings of the analog signal.

In that respect the factor by which the interpolator improves resolution is to be adjustable.

The improvement in resolution is achieved insofar as the shape of the underlying analog signal is known and the instantaneous position on the ordinate 28b which is in the measuring direction is known from the value of the abscissa 28a of the analog signal and the gradient thereof, within a period of the analog signal.

The periodic digital signal produced is generally reproduced in the form of a rectangular signal 29 and preferably—for the sake of detectability of the direction of movement in the positive or negative measuring direction 10 and for improving signal security—in the form of two analog digital rectangular signals 29a, 29b which are phase-shifted relative to each other, wherein the phase shift differs from half a phase, that is to say it is about 90°, as it is only then that the direction of movement can be detected from the comparison of the two digital signals 29a, 29b.

Preferably each of the digital rectangular signals, as shown with reference to the signal 29b, can additionally also be transmitted once again as an additional inverted signal in order once again to enhance transmission security.

The electronic system further includes an output unit 9c in order to be able to forward the digital signal either to a display unit, for example a digital display 30, as shown in FIG. 2, or to a further processing unit comprising a machine control or a computer 31, as also indicated in FIG. 2.

FIG. 5 further shows that at least the converter 9a and the interpolator 9b of the electronic system 9 are disposed together with the sensor 2a within a structural unit, the sensor unit 2, which is movable in the measuring direction 10 relative to the measuring scale 1.

The output unit 9c is mostly in the form of a plug at the end of a cable leading away from the sensor unit 2.

FIGS. 1 through 4 show structural forms of the device and in particular the sensor unit 2 thereof in respect of its physical configuration. In that respect the sensor unit 2 is in fact generally arranged on a movable component—not shown in the Figures—of a machine, the position of which is to be detected, while the measuring scale 1, on the surface of which the sensor unit 2 is moved in the measuring direction 10, is mounted to a fixed part of the machine.

As the sectional view in FIG. 2 better shows, the measuring scale 1 comprises a magnetic band la in which segments 27a, 27b are provided continuously alternately in succession on at least one track 16a in the measuring direction 10, each segment being of the same length but magnetised differently, for example oppositely as North and South poles.

A further track 16b can have a reference mark 32 mostly arranged at only one single longitudinal position on the measuring scale 1, which then in most cases represents the zero position of the system.

In addition there can be further tracks with continuously alternately successively arranged segments as described in relation to the track 16a, but under some circumstances of a different and in particular a multiple length of those segments in the measuring direction with respect to that of the track 16a or all other tracks, in particular when the device is an absolute-measuring length measuring system.

That magnetic band la can be covered for mechanical protection on the top side thereof by a high-quality steel band 1b or an abrasion-resistant plastic band, and it can be equipped on the underside with an adhesive layer 1c, for mounting to the desired support.

In that case the reference mark 32 does not have to be an integral component part of the magnet band la and therewith the rest of the measuring scale 1.

The measuring scale 1 may also include only the continuously alternately magnetised tracks like the track 16a while the reference mark 32 is fixed in place as a separate short portion only at a longitudinal position beside the track 16a, for example also being fixed in place by adhesive, in dependence on the requirements of the respective situation of use.

In that case it is appropriate for that reference mark 32 which must be very accurately positioned to be arranged in correlated relationship with a given longitudinal position of the sensor unit 2 and therewith the machine component fixed to the sensor unit 2. For that purpose it is possible, as shown in FIG. 5, for that separate reference mark 32 to be provided with an abutment 26 which protrudes in the perpendicular 12 to the measuring direction 10 and against which the end face 33 of the sensor unit 2 can abut so that this sensor unit 2 together with the machine part carrying it is moved into the desired position and then the reference mark 32 is fixed in position, with the abutment 26 bearing against the sensor unit 2, beside the track 16a of the measuring scale 1.

In all cases it is important that—as shown in FIG. 2—the one or more sensors 2a, 2b arranged within the sensor unit 2 move at such a spacing in the transverse direction 11 of those tracks 16a, 16b which they are intended to sense.

For that purpose the electronic system arranged within the sensor unit 2 is arranged on one or more circuit boards, preferably on two mutually parallel rigid boards 13a, 13b, and teemed therearound.

In this case the electronic system is disposed either in the interior of a housing (not shown) or the electronic system is teemed after being positioned in a mold 22, as shown in FIG. 2, in which case the mold 22 is then removed again and the encasing for the electronic system consists exclusively of the teeming material 21.

As can be seen from FIGS. 1, 2 and 4 which relate to the same structural configuration, the two boards 13a, 13b which are disposed in parallel relationship extend in the measuring direction 10 and in the perpendicular 12 which projects perpendicularly from the plane of the measuring band which is defined by the measuring direction 10 and the transverse direction 11 extending transversely with respect thereto, at a uniform spacing. In that case the components on the boards 13a, 13b are preferably provided on the mutually facing inward side, which additionally makes it difficult for damage to occur from the exterior.

In that arrangement the boards 13a, 13b extend with their front edges 17a, 17b to close to the front face 34 of the sensor unit 2.

The present design has two sensors 2a, 2b within the sensor unit 2, corresponding to the two tracks 16a, 16b, provided on the measuring scale 1. Those sensors 2a, 2b are respectively arranged on one of the fixed boards 13a, 13b adjacent to or directly at the front edge 17a, 17b thereof, preferably in the longitudinal direction, the measuring direction 10, approximately at the center of those boards 13a, 13b.

With respect to the front face 34 of the sensor unit 2, which faces towards the measuring scale 1, the sensors 2a, 2b are thus only set back so slightly that they are covered by a thin layer of the teeming or casting material 21 as mechanical protection and protection from fouling and contamination.

The two fixed boards 13a and 13b are connected together by way of a flexible board 13′ which projects at the rear edge 19a, 19b of each board 13a, 13b, which edge is remote from the front edge 17a, 17b. That can provide that, before installation in the sensor unit 2, the entire board 13, that is to say comprising the two fixed boards 13a, 13b and the flexible board 13′ which connects them and which has conductor tracks substantially connecting the two fixed boards, can be fitted with components and handled in a developed condition, that is to say when laid out in a plane, as shown in FIG. 4.

So that the interpolator 9b which is also disposed on the boards can also be subsequently adjusted or set in respect of its factor, contact points 6a, 6b . . . of the sensor 2, after manufacture thereof, must still be reachable, in order thereby to be able to re-program by means of programming the interpolator 9b which is generally in the form of a chip 4.

Particularly if the electronic system 9 is teemed with material therearound within a housing of the sensor unit 2 after assembly, one of the boards 3a has a prolongation portion 20 which projects over the rear edge 19a which is otherwise present and extends only over a part of the length of the board 13a, with the contact points 6a, 6b . . . being disposed on the free end thereof. The connecting flexible board 13′ in contrast connects the two boards from the rear edge 19a, 19b . . . which is set back in relation thereto. In that way it is possible, within an existing housing of the sensor unit 2, to cast material around the electronic system 9 thereof by filling with teeming or casting material 21 from the rear face 35 to over the flexible board 13′ and also the rear edges 19a, 19b of the fixed boards 13a, 13b, so that after hardening has occurred only the free end of the prolongation portion 20 and therewith the contact points 6a, 6b thereof project from the teeming material and still remain accessible. The contact points 6a, 6b are then protected by closing the rear 35 of the sensor unit 2 by means of a cover (not shown in greater detail).

In contrast the cable 14 is preferably passed out of one of the end faces 36a, 36b of the sensor unit 2, which face in the measuring direction 10.

FIG. 3 is a plan view in the direction of view 3 showing another arrangement in a configuration in which the electronic system 9 is arranged within the sensor unit 2 also of only one single fixed circuit board 13. If however a plurality of mutually juxtaposed tracks, for example three tracks 16a, 16b, 16c of a measuring scale are to be sensed with such a sensor unit 2, the board 13 which also as shown in FIGS. 1 and 2 projects upwardly on the perpendicular 12 can be arranged at an acute angle inclinedly, that is to say in the cubic housing of the sensor unit 2, for example diagonally. That makes it possible for a plurality of sensors 2a, 2b, 2c to be arranged in each track in the leading direction of the board 13 spaced at the front edge thereof so that each of the sensors is in the transverse region of the track 16a, 16b or 16c to be sensed thereby.

FIG. 4 shows the overall circuit board 13 comprising the two boards 13a, 13b and the flexible board 13′:

This development in FIG. 4 shows the two rigid boards 13a, 13b in a mutually parallel position in one plane, with front edges 17a, 17b facing away from each other and rear edges 19a, 19b facing towards each other. In this case that rear edge 19a of the one fixed board 13a is connected approximately at half of its longitudinal extent in the measuring direction 10 to the other rear edge 19b by a flexible board 13′, wherein the flexible board 13′ is preferably formed together in one piece with the corresponding coatings of the rigid boards 13a, 13b and can thus be produced in the form of a unitary board.

At the front edges 17a, 17b the boards each have on both sides of the center bay portions 37 so that projections 38a remain at the ends of the front edge and a projection 38b remains in the middle. Mounted on the central projection 38b—as closely as possible to the front edge—is a respective sensor 8a and 8b in the form of an on-board chip, that is to say in the form of a bare non-housed chip, by means of bonding or even the flip-chip procedure, and electrically connected. The laterally outer projections 38a project somewhat further than the central projection 38b and when the sensor unit 2 is supported on a flat support in the teeming operation ensure that the sensors 8a, 8b are set back somewhat with respect to the later front face 15 of the sensor unit 2 and are covered by a layer of teeming material.

In the other half of the rear edge 19a of the one fixed board 13a the prolongation portion 20 projects towards the other fixed board 13b which at its free ends has the contact points 6a, 6b. Arranged on one of the rigid boards 13b are solder points 39a, 39b, 39c which serve for connection of the individual wires of the cable 8 which serves to pass the processed signals to an output unit.

Besides discrete electronic components, also mounted on the respective boards 13a, 13b are a chip 4, 5, in particular in each case also in non-housed bare form, wherein preferably of the additional chips each is arranged on one of the boards, and therewith also the converter 9a on the one hand and the interpolator 9b on the other are disposed substantially on separate fixed boards 13a, 13b.

FIG. 4 also shows at respective ones of the corners of the boards 13a, 13b bores 40a, 40b which serve for mechanical fixing for example by means of screwing of such boards to another component, but which in the teeming operation serve for the teeming material to additionally pass through and go into undercut configuration behind the boards. Therefore, after the boards 13 in FIG. 4 have been folded over into a mutually parallel position of the fixed boards 13a, 13b, alignment of the bores 4a, 4b is also not absolutely necessary.

While in the construction shown in FIG. 4, that is to say with the prolongation portion 20 as shown in FIG. 2 projecting upwardly beyond the teeming material 21, the electronic system 9 and in particular the interpolator 9b can be contacted and is thus programmable within the sensor unit 2 even after the teeming operation, that is to say after it is finished in a suitable condition for use, it is also possible to envisage other possible ways of later contacting and therewith also programming by fitting a plug or other electrical contacts on to the contact locations 6a, 6b contacting unit 6.

As described with reference to FIG. 2 for the case of enclosing the electronic system 9 without using a housing, the outside of the teeming material 21 has contact openings 24 which pass from the outside of the teeming material to the board in the form of openings of small cross-section, caused by the supports 23 in the mold 22 in the teeming operation.

If those contact openings 24 are selected at locations of the contact points, it is possible thereby, by means of contact needles or the like, to make an electrically conducting connection to the electronic system although the electronic system is covered very substantially—more specifically except for the contact openings 24 of very small opening cross-sections—by the teeming material 21.

Contacting and therewith also programming can be effected by means of such contact needles even through a teeming material 21 which completely continuously encloses the boards 13a, 13b and from which therefore no prolongation portion 20 with contacting unit has to project, insofar as the contact needles are simply pushed through the hardened teeming material to the corresponding contact point on the outside of the board 13a, 13b. For that case it is recommended that the material selected as the teeming material 21 is a material which is sufficiently elastic and possibly even plastic even after hardening so that, after withdrawal of the contact needles, the openings formed thereby automatically close again by virtue of inherent elasticity or inherent plasticity.

FIG. 6 shows the circuit diagram illustrating the principle of the protective circuit. Disposed within the so-called internal circuit nodes is the actual evaluating electronic system comprising the interpolator 9b which generally also includes the converter 9a, a line driver circuit 9d and a voltage regulator.

In that respect it should be made clear that the internal circuit nodes—and likewise also the external circuit nodes which represent the boundary between the protective circuit and the surroundings—do not necessarily have to be physical nodes or intersections of conductor tracks, but can also be simple continuous conductor tracks, and this only means the boundary between individual circuitry functions or circuit parts.

In that respect the protective circuit has at the left and right edges of FIG. 6 outputs to the output unit 9c which is generally represented by the cable 14 which goes away from the head of the sensor unit 2 and which at its free end has a plug for connection to other devices.

The cable 14 includes on the one hand lines for the power supply to the sensor unit 2, which represent access to the protective circuit from the left-hand side in FIG. 6. The lines of the cable 14 for transmitting the output signals leave FIG. 6 on the right-hand side.

On the supply side (left) a varistor 41 which is to prevent pulsed overvoltages includes also protection from incorrect polarity of the power supply lines of the cable 14. This so-called mispolarity protection includes a current-dependent resistor 43 and a mispolarity protection diode 44. In the case of incorrect polarity that diode 44 short-circuits the supply voltage which is applied to the diode in the backward direction and the current strength is limited by the current-dependent resistor 43, the rise in current strength being limited by an inductor 42.

The inductor 42 as well as the current-dependent resistor 3 are connected in series in the supply conductor from which both the varistor 41 and also the mispolarity protection diode 44 are taken to ground and equally a respective capacitor goes to ground upstream and downstream of the two series-connected elements.

This kind of mispolarity protection has the advantage that no diode is connected in series and thus there is no voltage loss across the diode section. The circuit can be operated up to a supply voltage, for example 5V.

A lossy ferrite inductor is provided as the inductor 42, for absorptive filtering of high-frequency interference voltages.

On the output side (right) the protective circuit is of a two-stage nature:

On the one hand varistors 9 which are taken to ground from the individual output lines again limit pulsed overvoltages. The overvoltage component which possibly remains is kept away from the line driver circuit 9d by cap diodes 46, 47 which are connected to ground or the internal supply line of the cable. Connected in parallel with that internal supply line are capacitors 50 of high capacitance values so that the supply line can carry the pulse currents introduced by overvoltage pulses.

If due to incorrect polarity the supply voltage is applied to one of those output lines, short-circuit currents flow by way of the diodes 46, but in that case the short-circuit currents are limited by current-dependent resistors 48 so that the cap diodes cannot be destroyed.

Filter elements are further connected in the connecting lines between the electronic evaluation system and the diodes 2a, b, . . . and are connected to ground, which are intended to carry away electrostatic discharges applied to the sensors 2a, 2b.

FIGS. 7-11 concern configurations with a measuring scale 1 which, besides the one or more counting tracks 16, does not have an additional track for reference marks. If a plurality of counting tracks are used in mutually juxtaposed relationship, they generally involve different pitch divisions. In the following examples it is assumed that each measuring scale has only one single track 16 whose regular magnetic coding lies in the arrangement, alternate in the measuring direction 10, of magnetised segments, so-called codings, whose magnetisation axis from north to south extends transversely with respect to the measuring direction 10 and in particular also transversely with respect to the plane of the measuring scale in the measuring scale 1, and wherein the regular arrangement provides that those codings of equal length occur in succession with reversed polarity in each case in the measuring direction 10, so that, along a longitudinal edge of the measuring scale 1, a North pole of a coding always follows a South pole of the next coding and vice-versa.

In that respect FIG. 7 shows in principle the measuring scale 1 and the sensor unit 2 arranged thereabove as a plan view in their relative position so that it is possible to see the orientation of the individual codings or segments 27a, 27b as described above.

Arranged in the sensor unit 2 at or in the front face 15 thereof are on the one hand the position sensor 102 and on the other hand the reference sensor 102′ which are spaced in the measuring direction 10 by the spacing L3, measured between their respective axes of symmetry which extend perpendicularly to the plane of the measuring scale. The two sensors are connected by way of electric lines to the interpolator 9b which is disposed in the sensor 2 and delivers binary output signals A, B, Z, F which are fed by way of a cable 14 leading away from the sensor unit 2 to a unit for further processing, for example an output unit (not shown).

FIGS. 8 show the different stages in signal processing at the location of the reference mark 32 of a measuring scale 1 which involves two successively arranged segments 27a, 27b which are identical in respect at least of their magnetisation direction and orientation.

When passing over the regularly coded regions of the measuring scale 1 the position sensor 102—as shown in FIG. 7—produces two sinusoidal analog signals which are shifted for example through 90° relative to each other, a so-called sine signal and a so-called cosine signal. As the position sensor covers over and simultaneously detects a total of four codings 27a, 27b, . . . in the measuring direction, those analog signals of which by way of example the sine signal is illustrated are scarcely influenced by the irregular coding of the reference mark (segments 27a, 27b).

The analog sine and cosine signals are fed to the interpolator 9b which, from that pair of signals, produces a pulse sequence of digital, that is to say binary signals, in the form of two binary output signals (for example rectangular signals) which are displaced through for example 90°, the so-called A-signal and B-signal, as shown for example in FIG. 5 in the form of rectangular signals 29a, 29b.

With 200-times interpolation therefore the interpolator produces 200 signal rectangles in relation for example to the A-signal 29a for a single signal period of the analog sine or cosine signal. In addition the interpolator produces a binary index signal I which is a relative index signal and which occurs only a single time within a period of the analog sine or cosine signal, that is to say within a single segment for example 27b of the coding, and the length of which is equal or a part of a period of the binary A- or B-signal.

FIG. 8a shows only the index signal I of the binary output signals.

In contrast the reference sensor 102′ only ever senses a single coding, for example 27a, in the measuring direction 10, and thereby produces an initially analog reference signal Za which reproduces double the length of the same magnetic coding at the reference mark 32 by virtue of a corresponding length in respect of time of the positive or negative amplitude.

After conversion into a digital reference signal Zd that is expressed at the corresponding location in a rectangle signal of increased length in relation to the rectangular signals which occur instead of normal regular coding.

Logical AND-gating results in the production from the binary index signals I and reference signals Zd of the singular binary reference signal Z in the form of a single rectangular pulse at the location of the reference mark 32.

In contrast FIG. 8b shows the production of the binary reference signal Z by a procedure whereby the analog sine signal is subtracted from the analog reference signal Za and the analog difference signal obtained in that way is digitised to give the binary reference signal Z.

FIG. 8c shows the production of a singular binary reference signal Z with a sensor unit 2 which—as shown in FIG. 9—has two reference sensors 102′, 102″ which are disposed at the same defined spacing L3 in the measuring direction 10 upstream and downstream of the position sensor 102 in the sensor unit 2.

The analog reference signals Za1 which are obtained from the two reference sensors 102′, 102″ and of which only one is of a time extent of an amplitude when reaching one of the two reference marks 32 or 32′ are added and—after halving of the total—a defined multiple of the analog sine signal is subtracted therefrom. That in turn gives an analog singular reference signal as shown in FIG. 8b and after conversion into a binary signal a singular binary reference signal Z.

If due to irregular coding no minor variation in the analog signal of the position sensor is also to be accepted, there is the possibility—as shown in FIG. 9—for the reference marks 32 and/or 32′ to be arranged outside the measuring length L1 required for normal measuring procedures, in a projection portion L2, which however extends the required overall length of the measuring scale 1 to L1+L2 or L1+2×L2, depending on whether reference marks are required at one or both ends as zero point marks and/or as measuring scale end marks of which one can also be at the same time a zero point mark.

In the case of the procedure shown in FIG. 8c the two analog reference signals Za1 and Za2 are not phase-shifted and by virtue of the knowledge of the spacing L1 from the position sensor 102, in particular the center thereof, in relation to the two reference sensors 102′, 102″, they are cleared by that spacing L3. This means that the phase positions of the signals are compared together as though the position sensor and the reference sensor were disposed at the same longitudinal position within the sensor unit.

In the case of the procedure shown in FIG. 8d—in contrast to FIG. 8a—it will be apparent that the spacing L3 between the position and the reference sensors does not necessarily have to be a multiple of the period length of a sine signal. In a corresponding manner the binary index signal I is displaced with respect to the analog sine signal, in particular the zero passage thereof in the positive direction, by for example degrees.

FIG. 8e shows—in addition to the situation in FIG. 8a—to the right of the reference mark 32 a measuring scale end mark 32′ which comprises so many successively identically oriented segments or codings that the length thereof is greater than the length of the sine waves which are covered by the position sensor and simultaneously detected. In that case the segments within the measuring scale end mark 32′ are magnetised in the same manner as within the reference mark 32.

As the position sensor 102 is set back with respect to the reference sensor 102 in the forward direction, that is to say in the direction of travel towards the measuring scale end mark 32′, the analog sine signal reproducing the position ends only within the mark 32′ after some segments corresponding to the spacing L3 while the analog reference signal already retains a continuing negative deflection after the actual beginning of the measuring scale end mark 32′, which deflection drops back to zero towards the end of the measuring scale end mark 32.

In a corresponding manner there is a singular reference signal ZF which at the mark 32 has a rectangular signal which is increased in length in comparison with the other rectangular signals and at the location of the mark 32′ a rectangular signal which is increased once again in length in relation thereto and the length of which approximately corresponds to the length of the measuring scale end mark 32′.

This means that conversion of the singular reference signal ZF into binary reference signals Z only gives rise to a binary reference signal of that kind at the location of the mark 32, but in contrast a plurality of successively occurring binary signals in the region of the mark 32′.

In addition a binary measuring scale end signal in the form of a rectangular signal can be produced directly from the analog sine signal of the position sensor, in such a way that the rectangular signal occurs only after decay of the analog sine oscillation, so that, besides the primary reference signal Z, a second measuring scale end signal is available for checking purposes.

FIG. 8f shows the formation of the binary reference signal ZF by virtue of formation of the sign of the analog reference signal Za. That can be effected by threshold value comparison with the mean value of Za.

FIG. 8g corresponds to the signal formation in the case of a measuring scale end signal 32′ in FIG. 8e, but without a reference mark 32 which precedes in the direction of travel.

FIGS. 10 and 11 show by way of example circuits for producing the analog sine and cosine signals A, B respectively and the absolute binary reference signal Z.

FIG. 10 shows a circuit arrangement for processing the output signals produced by the sensor unit 2. The measuring output signal of the sensor unit 2 comprises a cosine and a sine signal which are respectively fed to the interpolator 9b by way of a bridge circuit and an amplifier.

There, an analog reference signal Za′ is formed by subtraction or addition of the analog signal Za outputted by the reference sensor 102′ and the analog sine signal outputted by the position sensor 102. The formation of a binary reference signal ZF by threshold value comparison and logical linking with the index signal I are effected in the interpolator 9b which outputs the resulting binary singular reference signal Z, besides the binary position signals A and B, for further processing by a counting unit (not shown), by way of the cable.

FIG. 11a shows a circuit arrangement by means of which an error or fault signal can be produced if the spacing between the sensor unit and the measuring section exceeds a reference value.

The sine and cosine signals delivered by the sensor unit are again fed by way of a bridge circuit and an amplifier to a respective squaring member which deliver a sine square or a cosine square signal which are fed by way of an adder to a threshold value switch.

In the normal situation the addition of the sine square and the cosine square give a signal of constant amplitude which, in the event of a deviation from a reference value, triggers the threshold value switch.

The same circuit arrangement can also be used to define the beginning or the end of the measuring section, if therefore no measuring signal or no further measuring signal is triggered, so that the threshold value switch can be triggered thereby.

FIG. 11b shows a circuit arrangement which is the same in terms of its action as FIG. 11a and in which the sine and cosine signals are fed as output signals of the sensor unit to a respective comparator which operates on a logical OR-gate with inverting input. If for example for each half-period of the sine and the cosine signal, a respective rectangular signal is produced, then there is always a rectangular pulse present with the correct spacing between the sensor unit and the measuring section. In the case of a larger spacing between the sensor unit and the measuring section, the rectangular pulses become shorter until finally periods of time occur, in which there is no longer any such rectangular pulse. When that happens, the OR-gate responds. It will be appreciated that the same also applies for the beginning and the end of the measuring section.

The circuit arrangements for producing an error signal as shown in FIGS. 11a and b are alternatively also integrated as a component of the interpolation circuit 9b on the same semiconductor chip.

The bridge resistance in the bridge circuit of the position sensor element, in particular as shown in FIGS. 11a, 11b, is in that case at least 3 kOhms, preferably at least 10 kOhms, preferably at least 100 kOhms, preferably at least 1000 kOhms, wherein the bridge voltage is preferably at least 1.5V, preferably at least 3.3V, preferably at least 5V.

In the case of a high bridge resistance and a low supply voltage, there is the advantage that the entire device can be operated by means of battery, by virtue of the low current consumption.

In the case of a low bridge resistance and a high supply voltage in contrast there is the advantage that the arrangement is robust in relation to electromagnetic interference influences.

LIST OF REFERENCES

| | |
|---|---|
| 1 | measuring scale |
| 2 | sensor unit |
| 2a | sensor |
| 4 | first chip |
| 5 | second chip |
| 6 | contacting unit |
| 6a, 6b | contact points |
| 7 | programming unit |
| 8 | third chip |
| 9a | converter |
| 9b | interpolator |
| 9c | output unit |
| 10 | measuring direction |
| 11 | transverse direction |
| 12 | perpendicular to the measuring scale plane |
| 13a, 13b | board |
| 13′ | flexible board |
| 14 | cable |
| 15 | front face |
| 16 | track |
| 17a, 17b | front edge |
| 19a, 19b | rear edge |
| 20 | prolongation portion |
| 21 | teeming material |
| 22 | mold |
| 23 | support means |
| 24 | contact openings |
| 25 | light emitting diode |
| 26 | abutment |
| 27a, 27b | segments |
| 28 | signal |
| 29a, 29b | rectangular signal |
| 30 | digital display |
| 31 | computer |
| 32 | reference mark |
| 33a, b | end walls |
| 35 | rear |
| 36a, b | end faces |
| 37 | bay portions |
| 38a, b | projection |
| 39a, b, c | bores |
| 40a, b, c | bores |
| 41 | varistor |
| 42 | inductor |
| 43 | resistor |
| 44 | diode |
| 45 | filter elements |
| 46 | cap diode |
| 47 | cap diode |
| 50 | capacitor |
| L1 | measuring length |
| L2 | projection portion |
| L3 | spacing |
| A, B | analog sine and cosine signals |
| I | digital index signal |
| F | error signal |
| Z | absolute binary reference signal |

1. A length measuring device comprising
a measuring scale (1) which is coded alternately in the measuring direction (10),
a sensor unit (2) which is movable in the measuring direction (10) relative to the measuring scale and includes at least one sensor (2a) for contact-lessly detecting magnetically modulated analog signals, and
an electronic means (9) which includes
an interpolator (9b) for adjustably subdividing the pitch spacings of the digital signal with respect to that of the analog signal by a multiple factor, and
a line driver circuit (9d) for improving the transmission capability of the digital signal, and
an output unit (9c) for outputting the digital signals delivered by the interpolator (9b),
characterised in that
the interpolator (9b) and the line driver circuit (9d) is arranged in the sensor unit (2).

2. A length measuring device comprising
a measuring scale (1) which is coded alternately in the measuring direction (10),
a sensor unit (2) which is movable in the measuring direction (10) relative to the measuring scale and includes at least one sensor (2a) for contact-lessly detecting magnetically modulated analog signals, and
an electronic means (9) which includes
an interpolator (9b) for adjustably subdividing the pitch spacings of the digital signal with respect to that of the analog signal by a multiple factor, and
a line driver circuit (9d) for improving the transmission capability of the digital signal, and
an output unit (9c) for outputting the digital signals delivered by the interpolator (9b),
characterised in that
in the sensor unit (2) the electronic means (9) includes a protective circuit for protecting the electronic components of the electronic means (9) from overloading by excessively high voltages and/or currents.

3. A device as set forth in claim 2 characterised in that
the protective circuit also protects against incorrect polarity of the output unit (9c), and/or in particular
the protective circuit is a component part of the interpolator (9b) and/or the power driver (9d) and/or a voltage regulator, and/or in particular
the protective circuit includes current-limiting impedances and/or discharge elements for carrying away overvoltages and/or voltage-limiting components, and/or in particular
the adjustable parameters, in particular the subdivision factor, of the interpolator (9b) is still adjustable even after ready-for-use manufacture of the sensor unit (2).

4. A device as set forth in one of the preceding claims characterised in that
the interpolator (9b) includes a programmable first chip (4) and a contacting unit (6) in order to be able to re-program the first circuit, in particular the chip (4), in particular for the purposes of altering the factor, by the connection of a programming unit (7), and/or in particular
the contacting unit (6) is accessible even after ready-for-use manufacture of the sensor unit (2), and/or in particular
the contacting unit (6) is provided separately from the output unit (9c), in particular the electrical contacts thereof, and in particular is arranged within the sensor unit (2), and/or in particular
the contacting unit (6) is in the form of part of the output unit (9c), in particular the electrical contacts thereof, and the interpolator remains programmable in particular by way of the cable of the output unit.

5. A measuring device as set forth in one of the preceding claims characterised in that
the line driver circuit (9d) includes a second circuit, in particular a chip (5), and/or in particular
the sensor (2a) is in the form of a third circuit, in particular a chip (8), and is installed within the sensor unit (2) in the form of a bare chip.

6. A length measuring device comprising
a measuring scale (1) which is coded alternately in the measuring direction (10),
a sensor unit (2) which is movable in the measuring direction (10) relative to the measuring scale and includes at least one sensor (2a) for contact-lessly detecting magnetically modulated analog signals, and
an electronic means (9) which includes
an interpolator (9b) for adjustably subdividing the pitch spacings of the digital signal with respect to that of the analog signal by a multiple factor, and
a line driver circuit (9d) for improving the transmission capability of the digital signal, and
an output unit (9c) for outputting the digital signals delivered by the interpolator (9b),
characterised in that
the sensor unit (2) includes at least one board (13a .) with electronic components which is arranged in the sensor unit (2) in a position not parallel to the plane of the measuring band (1) and thus also in a position not parallel to the front face (15) of the sensor unit (2), and/or in particular
the board (13a) is arranged parallel to the measuring direction (10) in the sensor unit (2), and/or in particular
the board (13a) is arranged at an acute angle relative to the measuring direction (10) in the sensor unit (2) and in particular the sensor unit (2) is no wider than the transverse direction (11) of the measuring scale (1), and/or in particular
the measuring scale (1) has a plurality of tracks (16a, b . . . ) which are disposed in mutually juxtaposed relationship in the transverse direction (11) and which in particular are all alternately magnetised, but the pitch spacing of the individual tracks (16a, b . . . ) is different, and the sensor unit (2) includes a plurality of sensors (2a, b . . . ) corresponding to the number of tracks (16a, b . . . ) and each of the sensors (2a, b . . . ) is arranged on a separate rigid board (13a, b) at the front edge (17a, b . . . ) thereof, and/or in particular
the rigid boards (13a, b . . . ) are connected by way of flexible conductors, in particular at least one flexible board (13′), all flexibly to form a prefabricated structural unit, and/or in particular
the flexible conductors, in particular the flexible board (13′), project from the rear edge (19a, b) of each board (13a, b . . . ), which is remote from the front edge (17a, b . . . ), and/or in particular
the contact points (6a, b . . . ) of the contacting unit (6) are arranged on a prolongation portion (20) which projects beyond the rest of the rear edge (19a) of a board (13a), and/or in particular
at least one circuit and in particular all circuits used within the sensor unit (2), in particular chips (4, 5, 8 and 8a, b respectively), are used as bare chips, and/or in particular
the circuits, in particular chips, are fixed on and electrically connected on the boards by means of bonding, therefore in particular pre-fixing by means of adhesive and subsequent electrical contacting by means of soldering, or by means of the flip-chip procedure.

7. A length measuring device comprising
a measuring scale (1) which is coded alternately in the measuring direction (10),
a sensor unit (2) which is movable in the measuring direction (10) relative to the measuring scale and includes at least one sensor (2a) for contact-lessly detecting magnetically modulated analog signals, and
an electronic means (9) which includes
an interpolator (9b) for adjustably subdividing the pitch spacings of the digital signal with respect to that of the analog signal by a multiple factor, and
a line driver circuit (9d) for improving the transmission capability of the digital signal, and
an output unit (9c) for outputting the digital signals delivered by the interpolator (9b),
characterised in that
the parts of the electronic means (9), which are arranged within the sensor unit (2), are arranged on at least one board (13) and enclosed by means of a hardening teeming material (21), and/or in particular
the electronic means (9) of the sensor unit (2) is completely enclosed by the teeming material (21), and/or in particular
the teeming material (21) is a polymer, in particular an elastomer, in particular a thermoplastic material, and/or in particular
the sensor unit (2) is housing-less, that is to say beyond the enclosure of teeming material (21), it does not have any further, in particular fixed enclosure.

8. A device as set forth in one of the preceding claims characterised in that
the electronic means (9) includes a contacting unit (6) within the sensor unit (2), the contact points (6a) of which are also covered by the teeming material (21), but are contactable by means of contact points which penetrate from the exterior through the teeming material (21), and/or in particular
the electronic means (9) includes a contacting unit (6) with contact points (6a, b . . . ) within the sensor unit (2), and enclosure of the electronic means (9) by means of teeming material (21) is effected in a mold (22) within which the at least one fixed board (13a) of the electronic means (9) is held at a spacing relative to the outside wall of the mold (22) by means of pin-shaped support means (23) of smallest possible cross-section, projecting towards the board (13a), and the support means (23) are arranged in particular at the location of the contact points (6a, b . . . ) of the contacting unit (6) and bear against same in order thus to create in the subsequent enclosure of teeming material (21) contact openings (24) in the teeming material (21), and/or in particular
the sensor unit (2) has at least one optical and/or acoustic indicator, in particular an optical indicator in the form of at least one light emitting diode (25), and/or in particular
the optical and/or acoustic indicator at the sensor unit (2) is a zero position indicator which indicates when the sensor unit is at the zero position of the measuring scale, in particular the reference mark thereof, and/or in particular
the indicator is an error indicator which indicates when the sensor unit (2) is defective, for example by virtue of an excessively large spacing from the measuring band or an excessively high speed of travel.

9. A device as set forth in one of the preceding claims characterised in that
light emitting diodes (25) as indicators are so arranged in the interior of the sensor unit (2) that they are visible from at least two directions of view spaced through 90°, in particular in the region of the rearward corners of the sensor unit (2), in particular covered under a transparent cover means, in particular a transparent cable-insertion sleeve, and/or in particular
light emitting diodes as indicators are arranged at or in the underside of the sensor unit (2), covered at most by transparent material, so that the illumination thereof is visible by reflection on the high-quality steel band covering the magnetic band, and/or in particular
a separate reference mark which is a component of the measuring scale (1) and which is freely positionable in the measuring direction (10) with respect to one of the other tracks (16a . . . ) of the measuring scale (1) has an abutment (26) for the sensor unit (2) in the measuring direction in order to be positionable with the sensor unit (2) at a defined location in the measuring direction (10).

10. A length measuring device comprising
a measuring scale (1) which is coded in the measuring direction (10) regularly, in particular alternately,
a sensor unit (2) which is movable in the measuring direction (10) relative to the measuring scale (1) and includes at least one sensor for contact-lessly detecting magnetically modulated analog signals, and
an electronic means (9) for evaluating the signals of the at least one sensor,
characterised in that
the sensor unit (2) includes at least one position sensor (102) and a reference sensor (102′) for contact-lessly detecting magnetically modulated analog signals, wherein the sensors (102, 102′) are arranged in succession in the measuring direction (10) at a defined sensor spacing (L3),
the measuring scale (1) has the reference mark (32) integrated in its regularly coded counting track (16) defined in the measuring direction (10), and/or in particular
the sensor unit (2) is so designed that when the sensors (102, 102′) travel over the reference mark (32) different analog signal are delivered by them, and in particular the design configuration of the sensor unit (2) for producing different signals when travelling over the reference mark (32) lies in the different design configurations of the two sensors (102, 102′), and/or in particular
the electronic means (9) includes at least
an interpolator (9b) for adjustably subdividing the pitch spacings of the digital signal with respect to that of the analog signal by a multiple factor, and
a line driver circuit (9d) for improving the transmission capability of the digital signal, and
an output unit (9c) for outputting the digital signals delivered by the interpolator (9b), and/or in particular
the sensor unit (2) is so designed that when the sensors (102, 102′) travel over the reference mark (32) different analog signals are delivered by them and in particular the design configuration of the sensor unit (2) for producing different signals when travelling over the reference mark (32) lies in the fact that the interpolator (9b) subjects the analog signals of the two sensors (102, 102′) to different further processing, and/or in particular
the position sensor (102) and the reference sensor (102′) extend over different numbers of individual codings of the measuring scale (1) in the measuring direction (10) and in particular the reference sensor (102′) extends only over the length of a single coding and the position sensor (102) extends over the length of four codings.

11. A device as set forth in one of the preceding claims characterised in that
the measuring scale (1) has equal-length codings in the form of individual magnetisations which are disposed transversely with respect to the measuring direction (10) and which alternately in succession in the measuring direction (10) have the North or the South pole associated with the one longitudinal edge of the measuring scale (1), and/or in particular
the reference mark (32) is a zero point mark, and/or in particular
the reference mark (32′, 32″) is a measuring scale end mark, and/or in particular
present as a reference mark (32, 32′, 32″) in the alternate sequence of oppositely oriented magnetic codings is a coding through 180° in opposite relationship to its reference coding which occurs in the regular succession, that is to say an odd number and in particular three, successively occurring identically oriented codings on the measuring scale (1), and/or in particular
present as a reference mark (32, 32′, 32″) in the alternate sequence of oppositely oriented magnetic codings are an even number and in particular two successively occurring identically oriented codings on the measuring scale (1).

12. A device as set forth in one of the preceding claims characterised in that
the output signal of the position sensor (102) includes mean value formation over a plurality of successive codings and the irregularity afforded by the reference mark (32) in the sequence of codings is so slight in its influence on the delivered analog signal from the position sensor (102) by virtue of the fact that the binary signal derived from that analog signal, in particular a rectangular signal (29a, 29b) is also continued unaltered in the region of the reference mark (32), and/or in particular
the sensor unit (2) has a respective reference sensor (102′) both in the positive and in the negative measuring direction (10) at the same spacing (L3) from the position sensor (102), and/or in particular
the measuring scale end marking includes a number of identically oriented codings in succession, which is greater than the number of identically oriented codings in the zero point mark, and/or in particular
the evaluation circuit includes a guide error recognition means for recognising an excessively great distance between the sensor unit (2) and the measuring scale (1), which includes in particular a square summing means or a value discriminator and logical linking of the binary sub-signals of the position sensor (102).

13. A length measuring device comprising
a measuring scale (1) which is coded in the measuring direction (10) regularly, in particular alternately,
a sensor unit (2) which is movable in the measuring direction (10) relative to the measuring scale (1) and includes at least one sensor for contact-lessly detecting magnetically modulated analog signals, and
an electronic means (9) for evaluating the signals of the at least one sensor,
characterised in that
the sensor unit (2) includes at least one position sensor (102) and a reference sensor (102′) for contact-lessly detecting magnetically modulated analog signals, wherein the sensors (102, 102′) are arranged in succession in the measuring direction (10) at a defined sensor spacing (L3), and
the measuring scale (1) has the reference mark (32) integrated in a separate, defined, regular, coded reference track extending parallel to the counting track.

14. A process for producing and assembling a length measuring device comprising
a measuring scale (1) which is coded alternately in the measuring direction (10), and
a sensor unit (2) which is movable in the measuring direction (10) relative to the measuring scale (1) and includes at least one sensor for contact-lessly detecting magnetically modulated analog signals,
characterised in that the measuring scale (1) is produced by
cutting to length an endlessly regularly, in particular alternately, magnetically coded measuring band, and
applying one or more reference marks (32, 32′, 32′″) by overwriting at least one of the regular magnetic codings by a magnetic coding with North and South pole interchanged with respect thereto (1800 phase change), and/or in particular
the operation of introducing the reference marks into the measuring scale (1) is effected after arranging the measuring scale (1) on the object of use, and/or in particular
the application operation is effected by means of a magnetising head which in particular includes a permanent magnet and in that procedure the magnetising head is effected in a defined relative position at the sensor unit (2) which is displaceable in the measuring direction (10) along the measuring scale (1) and which in particular in that case is also already fixed to the object of use.
